(19) United States
(12) Patent Application Publication
(10) Pub. No.: US 2026/0067047 A1
(43) Pub. Date: Mar. 5, 2026

(54) UNIFIED INITIAL CONTROL FRAME DESIGNS

(71) Applicant: QUALCOMM Incorporated, San Diego, CA (US)

(72) Inventors: Sanket Sanjay KALAMKAR, San Diego, CA (US); Abhishek Pramod PATIL, San Diego, CA (US); Gaurang NAIK, San Diego, CA (US); Sherief HELWA, San Diego, CA (US); Giovanni CHISCI, San Diego, CA (US); Alfred ASTERJADHI, San Diego, CA (US); George CHERIAN, San Diego, CA (US); Sai Yiu Duncan HO, San Diego, CA (US)

(21) Appl. No.: 19/315,024

(22) Filed: Aug. 29, 2025

Related U.S. Application Data
(60) Provisional application No. 63/690,416, filed on Sep. 4, 2024.

(51) Int. Cl. H04L 5/00; H04W 74/00

(52) U.S. Cl. CPC H04L 5/0053; H04W 74/002

(57) ABSTRACT

This disclosure provides methods, components, apparatuses, devices and systems for unified control frame designs. Some aspects more specifically relate to control frame designs according to which a single control frame structure, format, or interpretation is able to serve multiple signaling types or functionalities. In some examples, a wireless communication device may transmit a control frame and one or more fields of the control frame may indicate a presence of an information container within the one or more fields, an information type associated with the information container, and information, within the information container, in accordance with the information type. In some aspects, the indicated information type may correspond to a signaling type or functionality for which the control frame provides information. The control frame may indicate the presence of the information container via an identifier value within an inclusive range of between 2008 and 2044 or between 2047 and 4094.

### CROSS REFERENCE

The present Application for Patent claims the benefit of U.S. Provisional Patent Application No. 63/690,416 by Kalamkar et al., entitled “UNIFIED INITIAL CONTROL FRAME DESIGNS,” filed Sep. 4, 2024, assigned to the assignee hereof, and expressly incorporated by reference herein.

### TECHNICAL FIELD

This disclosure relates generally to wireless communication and, more specifically, to unified initial control frame (ICF) designs.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some wireless communication networks, a set or group of wireless communication devices may support one or more of various signaling types, each of which may be initiated by a separate frame exchange (as each signaling type may be associated with different types or amounts of information). Supporting separate frame exchanges for each of such various signaling types may add complexity and incur memory or processing costs.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communication at a wireless communication device. The apparatus or the wireless communication device may include a processing system that includes processor circuitry and memory circuitry that stores code. The processing system may be configured to cause the apparatus or the wireless communication device to transmit a control frame that includes one or more fields, the one or more fields indicating a first identifier value indicative of a presence of a first information container within the one or more fields of the control frame, a first information type associated with the first information container, and first information, within the first information container, in accordance with the first information type and receive a control response frame in association with transmitting the control frame.

Another innovative aspect of the subject matter described in this disclosure can be implemented in a method for wireless communication by or at wireless communication device. The method may include transmitting a control frame that includes one or more fields, the one or more fields indicating a first identifier value indicative of a presence of a first information container within the one or more fields of the control frame, a first information type associated with the first information container, and first information, within the first information container, in accordance with the first information type and receiving a control response frame in association with transmitting the control frame.

Another innovative aspect of the subject matter described in this disclosure can be implemented in an apparatus for wireless communication at a wireless communication device. The apparatus or the wireless communication device may include means for transmitting a control frame that includes one or more fields, the one or more fields indicating a first identifier value indicative of a presence of a first information container within the one or more fields of the control frame, a first information type associated with the first information container, and first information, within the first information container, in accordance with the first information type and means for receiving a control response frame in association with transmitting the control frame.

Another innovative aspect of the subject matter described in this disclosure can be implemented in a non-transitory computer-readable medium storing code for wireless communication by a wireless communication device. The code may include instructions executable by one or more processors (such as or via a processing system) to transmit a control frame that includes one or more fields, the one or more fields indicating a first identifier value indicative of a presence of a first information container within the one or more fields of the control frame, a first information type associated with the first information container, and first information, within the first information container, in accordance with the first information type and receive a control response frame in association with transmitting the control frame.

Another innovative aspect of the subject matter described in this disclosure can be implemented in an apparatus for wireless communication at a wireless communication device. The apparatus or the wireless communication device may include a processing system that includes processor circuitry and memory circuitry that stores code. The processing system may be configured to cause the apparatus or the wireless communication device to receive a control frame that includes one or more fields, the one or more fields indicating a first identifier value indicative of a presence of a first information container within the one or more fields of the control frame, a first information type associated with the first information container, and first information, within the first information container, in accordance with the first information type and transmit a control response frame in association with transmitting the control frame.

Another innovative aspect of the subject matter described in this disclosure can be implemented in a method for wireless communication by or at wireless communication device. The method may include receiving a control frame that includes one or more fields, the one or more fields indicating a first identifier value indicative of a presence of a first information container within the one or more fields of the control frame, a first information type associated with the first information container, and first information, within the first information container, in accordance with the first information type and transmitting a control response frame in association with transmitting the control frame.

Another innovative aspect of the subject matter described in this disclosure can be implemented in an apparatus for wireless communication at a wireless communication device. The apparatus or the wireless communication device may include means for receiving a control frame that includes one or more fields, the one or more fields indicating a first identifier value indicative of a presence of a first information container within the one or more fields of the control frame, a first information type associated with the first information container, and first information, within the first information container, in accordance with the first information type and means for transmitting a control response frame in association with transmitting the control frame.

Another innovative aspect of the subject matter described in this disclosure can be implemented in a non-transitory computer-readable medium storing code for wireless communication by a wireless communication device. The code may include instructions executable by one or more processors (such as or via a processing system) to receive a control frame that includes one or more fields, the one or more fields indicating a first identifier value indicative of a presence of a first information container within the one or more fields of the control frame, a first information type associated with the first information container, and first information, within the first information container, in accordance with the first information type and transmit a control response frame in association with transmitting the control frame.

In some implementations of the method, wireless communication devices, and non-transitory computer-readable medium described herein, the one or more fields include an identifier subfield and the identifier subfield indicates the first identifier value indicative of the presence of the first information container within the one or more fields.

In some implementations of the method, wireless communication devices, and non-transitory computer-readable medium described herein, the identifier subfield may be an association identifier (AID) subfield or an access point (AP) identifier (APID) subfield.

In some implementations of the method, wireless communication devices, and non-transitory computer-readable medium described herein, the first identifier value may be within an inclusive range of between 2008 and 2044 or between 2047 and 4094.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example control frame that supports unified initial control frame (ICF) designs in accordance with conveying an information container within one or more fields of the control frame.

FIG. 3 shows an example common information field that supports unified ICF designs in accordance with conveying or supporting an information container.

FIG. 4 shows an example user information field that supports unified ICF designs in accordance with conveying or supporting an information container.

FIG. 5 shows an example signaling diagram illustrating wireless communication between two or more wireless communication devices that support unified ICF designs.

FIGS. 6-9 show example control frame formats that support unified ICF designs in accordance with conveying or supporting an information container.

FIG. 10 shows an example user information field list that supports unified ICF designs in accordance with providing an information container via one or more special user information fields.

FIGS. 11 and 12 show example field sequences illustrating a distribution of information subfields across multiple fields that support unified ICF designs.

FIG. 13 shows an example control frame format that supports unified ICF designs in accordance with conveying or supporting an information container.

FIGS. 14 and 15 show example information containers associated with various signaling types that support unified ICF designs.

FIGS. 16 and 17 show example field sequences associated with various signaling types that support unified ICF designs.

FIGS. 18-20 show example user information field lists associated with various signaling types that support unified ICF designs.

FIG. 21 shows a block diagram of an example wireless communication device that supports unified ICF designs.

FIGS. 22 and 23 show flowcharts illustrating example processes performable by or at a wireless communication device that supports unified ICF designs.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a set or group of wireless communication devices may support one or more of various signaling types, each of which may be initiated by a separate frame exchange (as each signaling type may be associated with different types or amounts of information). Such various signaling types may include a dynamic power save (PS) (DPS) signaling type, a coexistence (CoEx) signaling type, a non-primary channel access (NPCA) signaling type, a coordinated beamforming (CBF) signaling type, a coordinated TDMA (C-TDMA) signaling type, a dynamic subchannel operation (DSO) signaling type, and a coordinated spatial reuse (C-SR) signaling type, among other examples. As described herein, a “signaling type” may refer or relate to a signaling mechanism, a signaling protocol, a functionality, a mode of operation, or a capability associated with (coordinated) wireless communication by or between two or more wireless communication devices.

To initiate one of such signaling types, two or more wireless communication devices may perform a frame exchange, such as a control frame exchange. The frame exchange may include an initial control frame (ICF) transmission by a first wireless communication device and one or both of an initial control response (ICR) or a control response frame (CRF) transmission by a second wireless communication device. An ICF may, for example, initiate a transmission opportunity (TXOP) or a frame exchange sequence. In some networks, the ICF may be a trigger frame, such as a buffer status report poll (BSRP) trigger frame. In some networks, the ICF may be formatted as or similar to a BSRP trigger frame. An ICR may confirm the TXOP or the frame exchange sequence. An ICF may be an immediate response frame. In networks in which some signaling types are associated with different types or amounts of information, the ICFs used to initiate such signaling types may be different (such as separately defined or formatted). Supporting separate ICFs for each of various signaling types may add complexity and incur memory or processing costs as, for example, a wireless communication device may be expected to be able to parse potentially many different ICF formats (including a potentially increasing quantity of different ICF formats as networks introduce additional signaling types or functionalities).

Various aspects relate generally to unified ICF designs. Some aspects more specifically relate to ICF designs according to which a single ICF structure, format, or interpretation is able to serve multiple signaling types or functionalities. In some examples, a wireless communication device may transmit a control frame (such as an ICF) and one or more fields of the control frame may indicate a presence of an information container within the one or more fields of the control frame, an information type associated with the information container, and information, within the information container, in accordance with the information type. In some aspects, the indicated information type may correspond to a signaling type or functionality, from multiple possible or available (such as supported) signaling types or functionalities, for which the control frame provides information. In some implementations, the control frame may indicate the presence of the information container via an identifier value of an association identifier (AID) or access point (AP) identifier (APID) subfield. Such an identifier value may be a numeric value within an inclusive range of between 2008 and 2044 or between 2047 and 4094. In other words, an AID or APID (AID/APID) subfield may indicate the presence of the information container by indicating a value of greater than 2007 (excluding 2045, 2046, and 4095).

The information container may include one or more of the AID/APID subfield, a subfield indicative of the information type, or the information. In examples in which the information container includes a subfield indicative of the information type, a single AID/APID subfield value (such as a value of 2008, among other examples) may indicate the presence of the information container. In examples in which the information container excludes a subfield indicative of the information type, the AID/APID subfield value may indicate the presence of the information container and the information type. For example, a first AID/APID subfield value (such as a value of 2008, among other examples) may indicate the presence of the information container and a first information type. By way of further example, a second AID/APID subfield value (such as a value of 2009, among other examples) may indicate the presence of the information container and a second information type. The information container may be located within a single field of the control frame (such as within a common information field, a user information field, or an information control field). Alternatively, the information container may be distributed across multiple fields. For example, a first field (such as a common information field, a first user information field, or an information control field) may include a first portion of the information container and a second field (such as a common information field, a second user information field, or an information control field) may include a second portion of the information container.

Particular aspects of the subject matter described in this disclosure can be implemented to realize one or more of the following potential advantages. In some examples, by structuring a control frame (such as an ICF) in accordance with a unified structure, format, or interpretation to serve multiple signaling types or functionalities, the described techniques can be used to achieve implementation simplicity (reduced complexity) while still supporting potentially many different signaling types or functionalities. Further, by conveying information specific to a given signaling type within an information container identified by an identifier value within an inclusive range of between 2008 and 2044 or between 2047 and 4094, the described techniques can be used to achieve backward and forward compatibility of the control frame. For example, by using an identifier value within an inclusive range of between 2008 and 2044 or between 2047 and 4094 to indicate the presence of the information container, the control frame may still trigger (such as include information that triggers or solicits) responses from devices of a first (such as lower) capability while providing information for devices of a second (such as higher) capability via the information container. In accordance with achieving such reduced complexity and backward and forward compatibility, the described techniques can be further implemented to realize or achieve longer battery life due to lower processing or memory costs. The described techniques also can be further implemented to realize or achieve greater spectral efficiency, higher data rates, and greater network capacity, among other benefits, due to simpler and more unified signaling designs or mechanisms to adapt between different signaling types or functionalities.

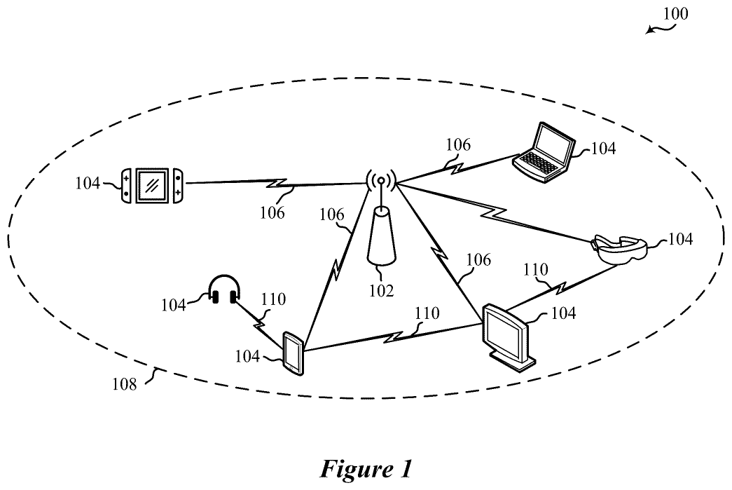

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an AID to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and UHR operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

In accordance with some example implementations of the present disclosure, a transmitting wireless communication device (such as an AP 102 or a STA 104) may transmit a control frame in accordance with a structure, format, design, or interpretation according to which one or more receiving wireless communication devices (such as one or more APs 102, one or more STAs 104, or any combination thereof) may obtain an indication of a presence of an information container within the control frame, an indication of an information type associated with the information container, and information in accordance with the information type. The transmitting wireless communication device may provide or convey such indications via one or more bits, subfields, fields, or elements of the control frame. As described herein, although a subfield may generally be indicative of a set or group of bits within a larger field, the terms “subfield” and “field” may be used interchangeably. For example, an “information type subfield” or an “information subfield” may be equivalently referred to as an “information type field” or an “information field.”

In some examples, the control frame may include, provide, indicate, or carry information that allows, facilitates, or enables differentiation (by a wireless communication device, such as a device receiving the control frame) between signaling types associated with different versions, generations, amendments, or capabilities of devices or standards specifications. For example, a wireless communication device receiving the control frame may use information conveyed by or via the control frame to differentiate between an 802.11bn signaling type (such as a UHR signaling type) and signaling types associated with other versions, generations, amendments, or capabilities of devices or standards specifications. In other words, the control frame may have a format that is able to provide information associated with an 802.11bn signaling type without sacrificing or losing a baseline structure of a BSRP trigger frame, which may be able to provide information associated with other signaling types, such as 802.11ax or 802.11be signaling types, among other examples. For example, the control frame may be backward and forward compatible, such that a same control frame may be able to provide information to (or solicit a response from, or both) a first device (an AP 102 or a STA 104) associated with a first capability or generation (such as 802.11ax or 802.11be) while also providing information to (or soliciting a response from, or both) a second device (an AP 102 or a STA 104) associated with a second capability or generation (such as 802.11bn). In some aspects, the information container within the control frame may correspond to or otherwise be associated with a version, capability, or generation, such as 802.11bn (potentially along with one or more other 802.11 specifications or amendments). In some examples, the control frame may include multiple identifier values, each identifier value indicative of a presence or location of information associated with a respective signaling type, version, capability, or generation, such as 802.11bn (potentially along with one or more other 802.11 specifications or amendments).

The control frame may be a trigger frame, such as a BSRP Trigger frame. The information conveyed by the control frame may include solicited information (such as solicited feedback information, unsolicited information (such as unsolicited feedback information), or may solicit additional information from the one or more receiving wireless communication devices. The control frame may involve a single user (such as a single AP 102 or a single STA 104) or multiple users (such as by soliciting responses from multiple devices). The control frame may be formatted in accordance with such a flexible use of the control frame, such as to be able to solicit a response from a single user or from multiple users. Further, in some implementations, the control frame may solicit trigger-based (TB) or non-TB responses. For example, a single user response may not be TB, such that the single user may respond in a non-high throughput (HT) (duplicate) PPDU. In some aspects, the control frame may solicit a TB PPDU response in a multi-user (MU) case and may solicit a non-TB PPDU response in a single user (SU) case. The control frame may include, in the MU case, common information. Such common information may be or include information pertaining to (such as applicable or usable by) multiple users. Example common information may include a soliciting of a response about buffer status report or an access category for which a TXOP can be shared in C-TDMA, among other examples. Additionally, or alternatively, the control frame may include, carry, or provide user-specific information.

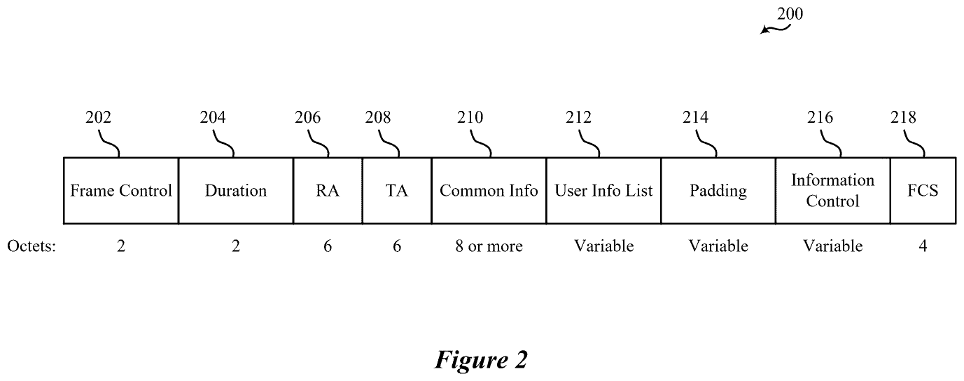

FIG. 2 shows an example control frame 200 that supports unified ICF designs in accordance with conveying an information container within one or more fields of the control frame. The control frame 200 may be an example of a trigger frame (such as a BSRP Trigger frame) and, in some implementations, may function as an ICF associated with a unified ICF design. For example, the control frame 200 may include one or more fields indicative of a presence of an information container within the one or more fields of the control frame 200, an information type associated with the information container, and information in accordance with the information type.

The control frame 200 may include one or more of a frame control field 202 of 2 octets, a duration field 204 of 2 octets, a receiver address (RA) field 206 of 6 octets, a transmitter address (TA) field 208 of 6 octets, a common information field 210 (shown as a “command info” field in the example of FIG. 2) of 8 or more octets, a user information field list 212 (shown as a “user info list” in the example of FIG. 2) of a variable quantity of octets, a padding field 214 of a variable quantity of octets, an information control field 216 of a variable quantity of octets, and a frame check sequence (FCS) field 218 of 4 octets.

The control frame 200 may function as or be a modified version of a BSRP Trigger frame and may solicit one or more responses as any one or more of an SU PPDU, a non-TB PPDU, or a TB PPDU format. The RA field 206 may indicate whether the control frame 200 is individually addressed or a broadcast frame. If the RA field 206 is indicative of a broadcast address, one or more wireless communication devices may use the control frame 200 for an MU case and a response to the control frame 200 may be in a TB PPDU format.

In some implementations, the control frame 200 may carry or include an information container within one or more of the common information field 210, the user information field list 212, or the information control field 216, among other fields within the control frame 200. The information container may be located within a single field of the control frame 200 or may distributed across multiple fields of the control frame 200.

In implementations in which the information control field 216 includes the information container, or at least a portion of the information container, the control frame 200 may include the information container after the padding field 214. In such implementations, the information container may be concatenated with other information, such as information indicative of an intermediate FCS or a MIC (which also may be conveyed via the information control field 216). In some examples, an information type may be assigned to indicate intermediate FCS or MIC, along with potentially other signaling types or functionalities. In accordance with the information control field 216 including the information container, a field including the information container may be located within the control frame 200 after a field including an identifier value having a value of 4095 (which may indicate padding). For example, a special user information field including the information container may appear after the indication of the start of the padding field 214 (which may be indicated by an AID value of 4095). Further, in implementations in which the information container is within the information control field 216 (after padding), the information container may exclude an AID12/APID12 subfield (and instead exclusively include an indication of an information type and information in accordance with the indicated information type).

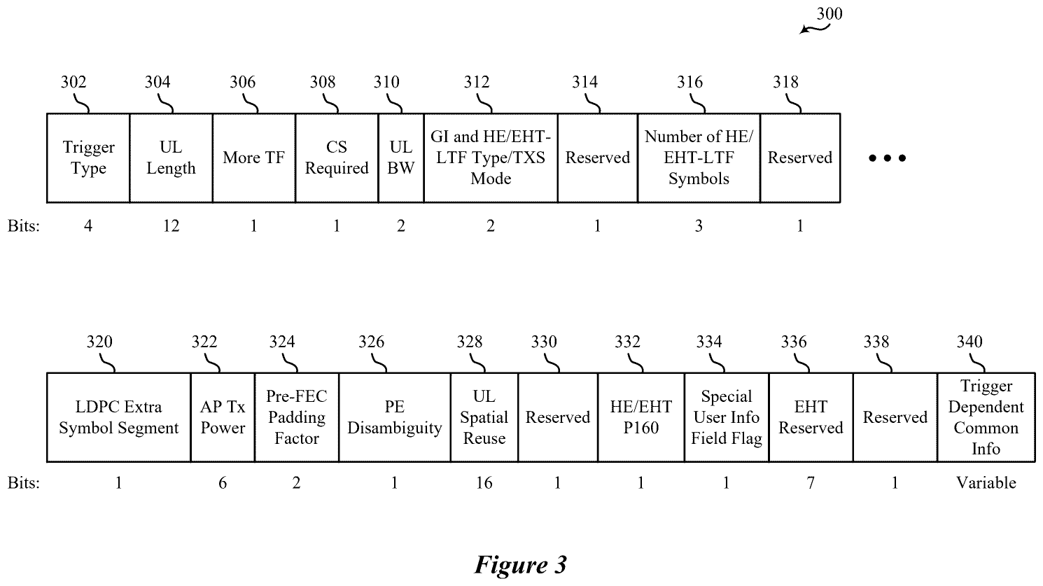

FIG. 3 shows an example common information field 300 that supports unified ICF designs in accordance with conveying or supporting an information container. The common information field 300 may be an example of the common information field 210 as illustrated by and described with reference to FIG. 2. In some implementations, the common information field 300 may include at least a portion of an information container, such as an information container associated with a version of the control frame.

The common information field 300 may include a trigger type subfield 302 of 4 bits, an uplink length subfield 304 (shown as an “UL length” subfield in the example of FIG. 3) of 12 bits, a more trigger frame subfield 306 (shown as a “more TF” subfield in the example of FIG. 3) of 1 bit indicative of whether or not a subsequent Trigger frame is scheduled for transmission, a carrier sense (CS) required subfield 308 of 1 bit, an uplink bandwidth subfield 310 (shown as a “UL BW” subfield in the example of FIG. 3) of 2 bits, a guard interval (GI) and high efficiency (HE)/EHT-long training field (LTF) type or TXOP sharing (TXS) mode subfield 312 (which may be referred to as a GI and HE/UHR LTF type/TXS mode subfield in a UHR system) of 2 bits, a reserved bits subfield 314 of 1 bit, a number of HE/EHT-LTF symbols subfield 316 of 3 bits, a reserved bits subfield 318 of 1 bit, a low-density parity check (LDPC) extra symbol segment subfield 320 of 1 bit, an AP transmit (Tx) power subfield 322 of 6 bits, a pre-forward error correction (FEC) padding factor subfield 324 of 2 bits, a packet extension (PE) disambiguity subfield 326 of 1 bit, an uplink spatial reuse subfield 328 (shown as an “UL spatial reuse” subfield in the example of FIG. 3) of 16 bits, a reserved bits subfield 330 of 1 bit, an HE/EHT P160 subfield 332 of 1 bit, a special user information field flag subfield 334 (shown as a “special user info field flag” subfield in the example of FIG. 3) of 1 bit, an EHT reserved bits subfield 336 of 7 bits, a reserved bits subfield 338 of 1 bit, and a trigger dependent common information subfield 340 (shown as a “trigger dependent common info” subfield in the example of FIG. 3) of a variable quantity of bits.

In some implementations, one or more wireless communication devices may repurpose any one or more of such subfields of the common information field 300 to include, carry, provide, or indicate at least a portion of an information container, such as an information container associated with a version of the control frame. For example, any one or more of such subfields of the common information field 300 may indicate an identifier value indicative of a presence of the information container, an information type associated with the information container, and information in accordance with the information type. In some examples, the one or more wireless communication devices may repurpose any one or more of such subfields of the common information field 300 to include, carry, provide, or indicate at least a portion of an information container in examples in which the control frame is sent for an SU case or purpose. For example, if the control frame including the common information field 300 is sent for an SU purpose, the response to the control frame may be in a non-TB PPDU format and, in such scenarios, at least some of the subfields within the common information field 300 may not be used (as such subfields may not be used to solicit non-TB PPDUs).

In other words, depending on whether a solicited response to the control frame is in a TB or a non-TB PPDU, one or more wireless communication devices may repurpose one or more subfields of the common information field 300 for one or more other uses, such as to include, carry, provide, or indicate at least a portion of an information container (such as an information container associated with a specific signaling type or functionality, such as an 802.11bn signaling type or functionality). Such subfields not used when a solicited response is transmitted via a non-TB PPDU format may include one or more of the GI and HE/EHT-LTF Type/TXS mode subfield 312 (or the GI and HE/UHR LTF type/TXS mode subfield), the reserved bits subfield 314, the number of HE/EHT-LTF symbols subfield 316, the reserved bits subfield 318, the LDPC extra symbol segment subfield 320, the AP Tx power subfield 322, the PE disambiguity subfield 326, the uplink spatial reuse subfield 328, the reserved bits subfield 330, the HE-EHT P160 subfield 332, the special user information field flag subfield 334, the EHT reserved bits subfield 336, the reserved bits subfield 338, and the trigger dependent common information subfield 340. Accordingly, an information container may start within any of such subfields within the common information field 300.

In some examples, a first portion of the information container may be within the common information field 300 and a second portion of the information container may be within one or more (special) user information fields or within an information control field, or any combination thereof. Such examples may include scenarios in which the information container is unable to fit entirely within the common information field 300. Additionally, or alternatively, a (special) user information field, such as a first or initial (special) user information field, may indicate the information type (such as the purpose of the control frame, such as whether the control frame is for CoEx, for C-TDMA schedule announcement/poll, or DSO, among other examples) and a remainder of the information container may be within the common information field 300. As described herein, a “purpose” of the control frame may be equivalently referred to or understood as a function, intention, capability, use, manner, signaling type, version, or generation of (or otherwise associated with) the control frame.

The control frame may indicate whether the control frame solicits a non-TB PPDU response or solicits a TB PPDU response. In some implementations, the control frame may indicate such information via one or more subfields of the common information field 300. For example, a value of the GI and HE/EHT-LTF Type/TXS mode subfield 312 (or the GI and HE/UHR LTF Type/TXS mode subfield) may indicate either that the control frame solicits a non-TB PPDU response or solicits a TB PPDU response. In such examples, a rule may indicate that, for example, a value of “11” (indicative of a codepoint value of three, where “00” may be a codepoint value of zero, “01” may be a codepoint value of 1, and “10” may be a codepoint value of two) within the GI and HE/EHT-LTF Type/TXS mode subfield 312 (or the GI and HE/UHR LTF Type/TXS mode subfield) indicates that the control frame solicits a non-TB PPDU response or that the control frame solicits a TB PPDU response.

Additionally, or alternatively, a combination of the GI and HE/EHT-LTF Type/TXS mode subfield 312 (or the GI and HE/UHR LTF Type/TXS mode subfield) and the reserved bits subfield 314 may indicate whether the control frame solicits a non-TB PPDU response or solicits a TB PPDU response. For example, a combination of “11” within the GI and HE/EHT-LTF Type/TXS mode subfield 312 (or the GI and HE/UHR LTF Type/TXS mode subfield) and “0” within the reserved bits subfield 314 may indicate that the response is solicited in a TB PPDU. By way of further example, a combination of “11” within the GI and HE/EHT-LTF Type/TXS mode subfield 312 (or the GI and HE/UHR LTF Type/TXS mode subfield) and “1” within the reserved bits subfield 314 may indicate that the response is solicited in a non-TB PPDU. Subsequent fields from the number of HE/EHT-LTF symbols subfield 316 may be interpreted in accordance with the indication of TB PPDU vs. non-TB PPDU. For example, if a non-TB response is solicited, the container for the common information may begin within the common information field 300, or the rest of the common information field 300 may be reserved, and the container of the common information may be within a (special) user information field.

Additionally, or alternatively, one or more reserved bits subfields within the common information field 300 may indicate whether a (solicited) response to the control frame is a TB or a non-TB PPDU. In other words, one or more reserved bits subfields within the common information field 300 may indicate whether the response is solicited in a TB PPDU or a non-TB PPDU. Such one or more reserved bits subfields may include the reserved bits subfield 314, the reserved bits subfield 318, the reserved bits subfield 330, the EHT reserved bits subfield 336, or the reserved bits subfield 338, or any combination thereof.

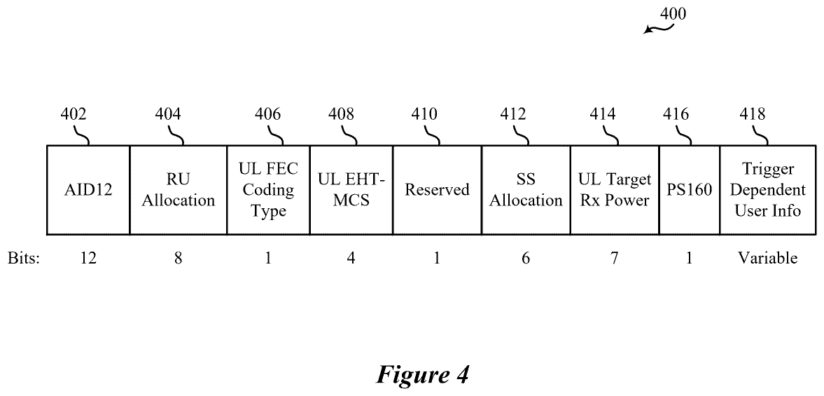

FIG. 4 shows an example user information field 400 that supports unified ICF designs in accordance with conveying or supporting an information container. The user information field 400 may be an example of a user information field within the user information field list 212 as illustrated by and described with reference to FIG. 2. In some implementations, the user information field 400 may include at least a portion of an information container, such as an information container associated with a version of the control frame.

The user information field 400 may include an AID12 subfield 402 (such as a 12-bit AID subfield, which may additionally, or alternatively, function as an APID12 subfield, such as a 12-bit APID subfield) of 12 bits, a resource unit (RU) allocation subfield 404 of 8 bits, an uplink FEC coding type subfield 406 (shown as a “UL FEC coding type” subfield in the example of FIG. 4) of 1 bit, an uplink EHT-modulation and coding scheme (MCS) subfield 408 (shown as an “UL EHT-MCS” subfield in the example of FIG. 4) of 4 bits, a reserved bits subfield 410 of 1 bit, a spatial stream (SS) allocation subfield 412 of 6 bits, an uplink target receive (Rx) power subfield 414 (shown as a “UL target Rx power” subfield in the example of FIG. 4) of 7 bits, a PS160 subfield 416 of 1 bit, and a trigger dependent user information subfield 418 (shown as a “trigger dependent user info” subfield in the example of FIG. 4) of a variable quantity of bits.

In some implementations, one or more wireless communication devices may repurpose any one or more of such subfields of the user information field 400 to include, carry, provide, or indicate at least a portion of an information container, such as an information container associated with a version of the control frame. For example, any one or more of such subfields of the user information field 400 may indicate an identifier value indicative of a presence of the information container, an information type associated with the information container, and information in accordance with the information type. Additionally, or alternatively, the user information field 400 may be associated with a unique or special format and may include, carry, provide, or indicate at least a portion of an information container in accordance with being associated with the unique or special format. Such a unique or special format of the user information field 400 may be indicated by a value of the AID12 subfield 402, such as by a value of the AID12 subfield 402 within an inclusive range of between 2008 and 2044 or between 2047 and 4094.

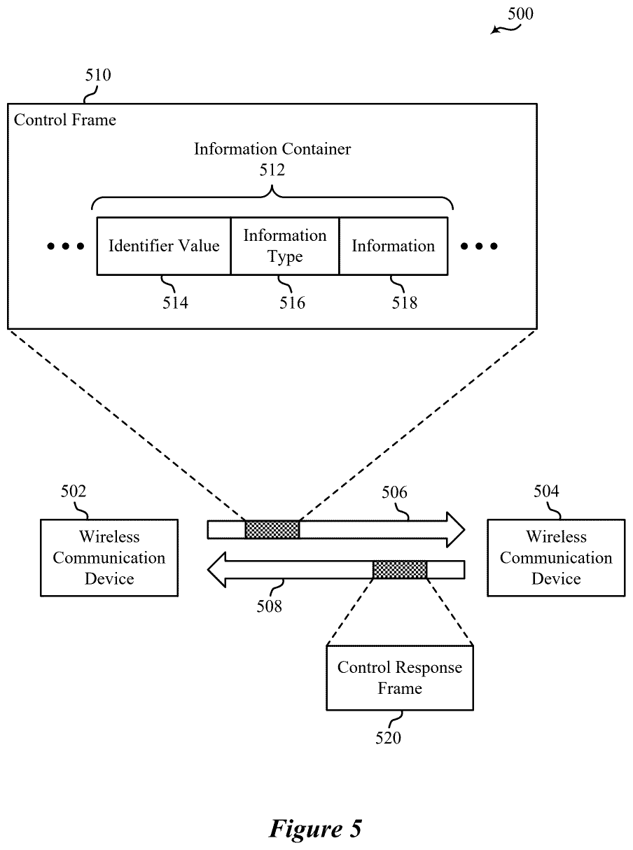

FIG. 5 shows an example signaling diagram 500 illustrating wireless communication between two or more wireless communication devices that support unified ICF designs. The signaling diagram 500 may implement or be implemented to realize one or more aspects of the wireless communication network 100, the control frame 200, the common information field 300, or the user information field 400. For example, the signaling diagram 500 illustrates wireless communication between a wireless communication device 502 and a wireless communication device 504, which may be examples of corresponding devices described herein. The wireless communication device 502 may be an AP 102 or a STA 104 and the wireless communication device 504 may be an AP 102 or a STA 104. In some aspects, one or both of the wireless communication device 502 and the wireless communication device 504 may be MLDs capable of communicating over multiple different links (such as two or more of a 2.4 GHz link, a 5 GHz link, and a 6 GHz link).

In some scenarios, the wireless communication device 502 may transmit wireless signaling to the wireless communication device 504 via a communication link 506 (such as an uplink, a downlink, a sidelink, or a backhaul link) and the wireless communication device 504 may transmit wireless signaling to the wireless communication device 502 via a communication link 508 (such as an uplink, a downlink, a sidelink, or a backhaul link).

In some implementations, the wireless communication device 502 may transmit, to at least the wireless communication device 504, a control frame 510. The control frame 510 may be an example of the control frame 200 as illustrated by and described with reference to FIG. 2. The control frame 510 may include, indicate, carry, or provide an information container 512, which may be associated with a version of the control frame 510. For example, a presence of the information container 512 within the control frame 510 may be indicative of the control frame 510 being associated with a specific version or of the control frame 510 providing information for devices associated with the specific version. In some implementations, the information container 512 may provide common information, such as information applicable or pertaining to potentially multiple receiving wireless communication devices, associated with a signaling type or functionality associated with the specific version (such as, for example, a signaling type or functionality associated with a UHR version or mode). Additionally, or alternatively, the information container 512 may include, indicate, carry, or provide user-specific information. For example, in addition to or as an alternative from including common information, the information container 512 may include information that is intended or addressed to a specific non-AP STA or a specific AP.

The control frame 510 may carry or provide the information container 512 via one or more fields (one or more of a common information field, one or more user information fields, or an information control field) of the control frame 510. Further, although the information container 512 is shown as being contiguous within the control frame 510 in the example of FIG. 5, the information container 512 may be non-contiguously distributed across the one or more fields of the control frame 510 in some other examples. In examples in which the control frame 510 carries or provides the information container 512 via the one or more fields, the one or more fields may indicate an identifier value 514 indicative of a presence (or a location, or both) of the information container 512 within the one or more fields of the control frame 510, an information type 516 associated with the information container 512, and information 518 in accordance with the information type 516. In some implementations, the information container 512 may be understood as being inclusive of an indication of the identifier value 514, an indication of the information type 516, and the information 518. In some other implementations, the information container 512 may be understood as being inclusive of a subset of an indication of the identifier value 514, an indication of the information type 516, and the information 518.

In some aspects, the control frame 510 may include an AID12/APID12 subfield indicative of the identifier value 514. The AID12/APID12 subfield may have a length or size of 12 bits. In such aspects, the identifier value 514 may correspond to an identifier for an associated STA 104 (AID12) or a coordinated AP in a coordinated AP (CAP) scheme (APID12). Such an identifier may be a special identifier, such as a special AID12/APID12 value, indicating that the one or more fields of the control frame 510 include the information container 512. In other words, the presence of a special AID12/APID12 value (the identifier value 514) may indicate that the field including the AID12/APID12 subfield is a special field (such as, for example, a special common information field or a special user information field) carrying common information for a version-specific signaling type or functionality (such as an 802.11bn signaling type or functionality). The identifier value 514 may be within an inclusive range of between 2008 and 2044 or between 2047 and 4094. In other words, the identifier value 514 may be a value greater than 2007, with the exception of 2045, 2046, and 4095 (to support forward and backward compatibility with various devices within the network, which may reduce communication errors and strengthen communication reliability).

In some implementations, a presence of the identifier value 514 (the special AID12/APID12 value, such as a value greater than 2007) may indicate that the control frame 510 is a unified ICF, such as that the control frame 510 is associated with a unified ICF design, format, structure, or interpretation. In such implementations, the wireless communication device 504 may parse at least a portion of the control frame 510 (such as the one or more fields) in accordance with the unified ICF design, format, structure, or interpretation. For example, the wireless communication device 504 may parse the control frame 510 to obtain the information container 512 in accordance with the identifier value 514 indicating that the control frame 510 is a unified ICF.

Additionally, or alternatively, the control frame 510 may include an information type subfield indicative of the information type 516. The information type subfield may have a length or size of 4 bits. The information type 516 may indicate a purpose (such as a function, intention, capability, use, manner, signaling type, version, or generation) of the control frame 510. In other words, the information type 516 may indicate for which signaling type or functionality the control frame 510 indicates information. For example, the information type 516 may indicate whether the control frame 510 is to indicate information for C-TDMA, CoEx, or NPCA, among other example signaling types or functionalities. In aspects in which the control frame 510 includes an information type subfield indicative of the information type 516, the wireless communication device 502 and the wireless communication device 504 may refrain from defining identifier values for each type of information that can be signaled/solicited by the control frame 510, which may provide more identifier values for potentially other uses and increase network capability. In such aspects, a same identifier value 514 (such as a value of 2008, among other examples) may indicate that the control frame 510 is a unified ICF and the information type subfield may indicate the information type 516 (in accordance with the identifier value 514 indicating that the control frame 510 is a unified ICF).

In some implementations, the control frame 510 may exclude an information type subfield indicative of the information type 516 and the identifier value 514 may (explicitly or implicitly) indicate the information type 516. In such implementations, the wireless communication device 502 may assign (such as indicate) a distinct AID12/APID12 value in accordance with the information type 516. For example, the wireless communication device 502 may set the identifier value 514 to a first value to indicate a first information type 516 and may set the identifier value 514 to a second value to indicate a second information type 516. In such examples, both the first value and the second value may indicate that the one or more fields of the control frame 510 include the information container 512. Further, in such examples, both the first value and the second value may be within an inclusive range of between 2008 and 2044 or between 2047 and 4094. By way of further example, an identifier value 514 of 2024 may indicate that the information type 516 corresponds to a C-TDMA signaling type or functionality and an identifier value 514 of 2025 may indicate that the information type 516 corresponds to a C-SR signaling type or functionality.

Additionally, or alternatively, the control frame 510 may include one or more information subfields indicative of the information 518. In such aspects, the one or more information subfields may contain the information 518, which may be information that is specific to the information type 516. A length of the information 518, or of the one or more information subfields carrying the information 518, may be fixed or static for a given information type 516, but may vary between information types 516. For example, a first information type 516 may be associated with a first length and a second information type 516 may be associated with a second length. In other words, an overall length of the information subfield(s) may vary (although fixed for a given signaling type or functionality) depending on the information type 516 and on the information provided/solicited. The information 518 may include, for example, unavailability information, a buffer status report (BSR), a resource request (such as a bandwidth-time product), a traffic priority (such as an AC, a traffic identifier (TID), a stream classification service (SCS) identifier (SCSID)), or a binary indication of a willingness or ability to participate in a CAP scheme (such as YES/NO), among other examples.

In some examples, the control frame 510 may include, within the information container 512 or elsewhere in one or more fields of the control frame 510, a bitmap field to indicate which signaling types or functionalities are enabled/signaled via the control frame 510. For example, each bit may indicate a signaling type or functionality for which information is signaled in the control frame 510. Each bit within the bitmap may correspond to a respective signaling type or functionality in accordance with a signaled, specified, or configured correspondence or mapping. By way of further example, a bit value of “1” may indicate that the control frame 510 includes information associated with a corresponding signaling type and a bit value of “0” may indicate that the control frame 510 does not include information associated with the corresponding signaling type.

Additionally, or alternatively, in examples in which at least one of the wireless communication device 502 and the wireless communication device 504 is an MLD capable of communicating via multiple links, the control frame 510 may include link information associated with the information container 512. The link information may be within the information container 512 or elsewhere in one or more fields of the control frame 510. Such link information may provide cross-link signaling associated with the information 518 conveyed by the information container 512. For example, a field or bitmap may indicate to which link the information 518 applies. For example, the control frame 510 sent on a first link (such as a link 1) for a first signaling type (such as DSO) also may include a special user information field carrying information for a second signaling type (such as CoEx) associated with a second link (such as a link 2). Generally, the link information may indicate that first information 518 pertaining to a first signaling type is applicable to a first set of one or more links and that second information 518 pertaining to a second signaling type is applicable to a second set of one or more links. The first set of one or more links may be different from, at least partially overlapping with, or the same as the second set of one or more links.

In association with transmitting the control frame 510, the wireless communication device 502 may receive, from the wireless communication device 504, a control response frame 520. The control response frame 520 may be an (approximately) immediate response (such as a short inter-frame space (SIFS) response) to the control frame 510 or may be a later response from the wireless communication device 504. The control response frame 520 may include an acknowledgment (ACK), a negative ACK (NACK), solicited information, scheduling or coordinating information, TXOP return information, or any combination thereof, among other examples. In examples in which the control response frame 520 includes solicited information, scheduling information, coordinating information, or TXOP return information, the information provided by the control response frame 520 may be in accordance with the information 518 provided by the control frame 510. For example, any scheduling or coordinating information provided by the control response frame 520 may comply with the information 518 indicated by the wireless communication device 502 via the control frame 510. Additionally, or alternatively, the control response frame 520 may include information that was indicated as being solicited by the information 518 of the control frame 510. The wireless communication device 504 may transmit the control response frame 520 at a specific rate, such as at 6 megabits per second (Mbps) or 12 Mbps, among other examples.

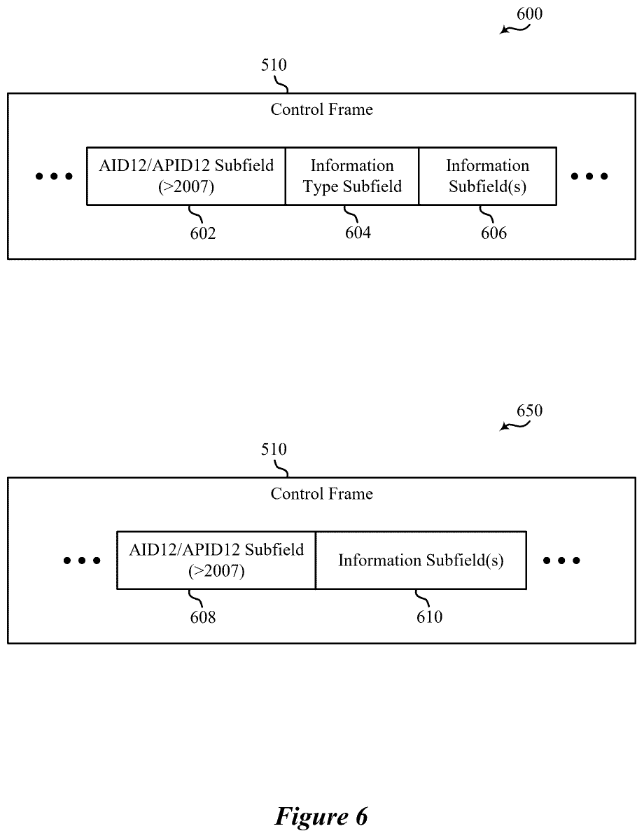

FIG. 6 shows example control frame formats 600 and 650 that support unified ICF designs in accordance with conveying or supporting an information container. The control frame formats 600 and 650 may implement or be implemented to realize one or more aspects of the wireless communication network 100, the control frame 200, the common information field 300, the user information field 400, or the signaling diagram 500. For example, the control frame 510 may be associated with a control frame format 600 or may be associated with a control frame format 650.

In examples in which the control frame 510 is associated with the control frame format 600, the control frame 510 may include an AID12/APID12 subfield 602, an information type subfield 604, and one or more information subfields 606. In such examples, the AID12/APID12 subfield 602 may indicate the identifier value 514, the information type subfield 604, may indicate the information type 516, and the one or more information subfields 606 may indicate the information 518. The AID12/APID12 subfield 602, the information type subfield 604, and the one or more information subfields 606 may be located within one or more fields of the control frame 510, such as in one or more of a common information field, one or more user information fields, or an information control field of the control frame 510. The AID12/APID12 subfield 602, the information type subfield 604, and the one or more information subfields 606 may be located consecutively or non-consecutively within the control frame 510. Further, the AID12/APID12 subfield 602, the information type subfield 604, and the one or more information subfields 606 may be located within a same field of the control frame 510 or may be distributed across multiple fields of the control frame 510.

In examples in which the control frame 510 is associated with the control frame format 650, the control frame 510 may include an AID12/APID12 subfield 608 and one or more information subfields 610. In such examples, the AID12/APID12 subfield 608 may indicate the identifier value 514 and the information type 516 and the one or more information subfields 610 may indicate the information 518. The AID12/APID12 subfield 608 and the one or more information subfields 610 may be located within one or more fields of the control frame 510, such as in one or more of a common information field, one or more user information fields, or an information control field of the control frame 510. The AID12/APID12 subfield 608 and the one or more information subfields 610 may be located consecutively or non-consecutively within the control frame 510. Further, the AID12/APID12 subfield 608 and the one or more information subfields 610 may be located within a same field of the control frame 510 or may be distributed across multiple fields of the control frame 510.

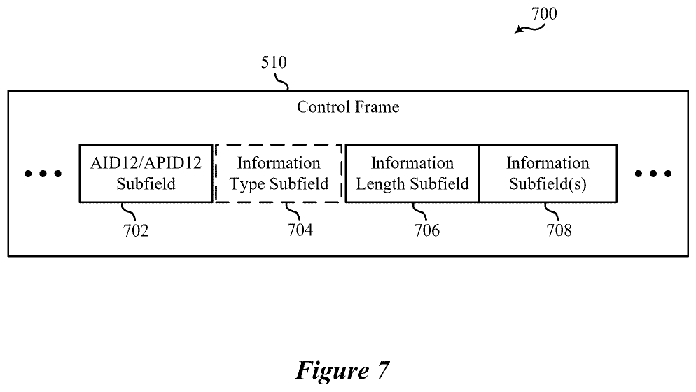

FIG. 7 shows an example control frame format 700 that supports unified ICF designs in accordance with conveying or supporting an information container. The control frame format 700 may implement or be implemented to realize one or more aspects of the wireless communication network 100, the control frame 200, the common information field 300, the user information field 400, or the signaling diagram 500. For example, the control frame 510 may be associated with a control frame format 700.

In examples in which the control frame 510 is associated with the control frame format 700, the control frame 510 may include an AID12/APID12 subfield 702, may optionally include an information type subfield 704, may include an information length subfield 706, and may include one or more information subfields 708. In such examples, the AID12/APID12 subfield 702 and the information type subfield 704 (if included) may indicate the identifier value 514 and the information type 516 and the one or more information subfields 708 may indicate the information 518. The information length subfield 706 may indicate an overall or total length of the one or more information subfields 708, or of the information 518 within the one or more information subfields 708. In some aspects, the information length subfield 706 may indicate an overall or total length of the one or more information subfields 708 including any reserved bits, if any. The information length subfield 706 may indicate the length in terms of bits or in terms of octets, or any combination thereof. In some examples, up to 8 octets may be included within the one or more information subfields 708 (the information-specific subfields). In accordance with including the information length subfield 706, the wireless communication device 502 transmitting the control frame 510 may flexibly or dynamically adjust the length of the one or more information subfields 708 (such as to occupy more or less of the control frame 510, as suitable depending on other information the wireless communication device 502 includes within the control frame 510).

The AID12/APID12 subfield 702, the information type subfield 704 (if included), the information length subfield 706, and the one or more information subfields 708 may be located within one or more fields of the control frame 510, such as in one or more of a common information field, one or more user information fields, or an information control field of the control frame 510. The AID12/APID12 subfield 702, the information type subfield 704 (if included), the information length subfield 706, and the one or more information subfields 708 may be located consecutively or non-consecutively within the control frame 510. Further, the AID12/APID12 subfield 702, the information type subfield 704 (if included), the information length subfield 706, and the one or more information subfields 708 may be located within a same field of the control frame 510 or may be distributed across multiple fields of the control frame 510.

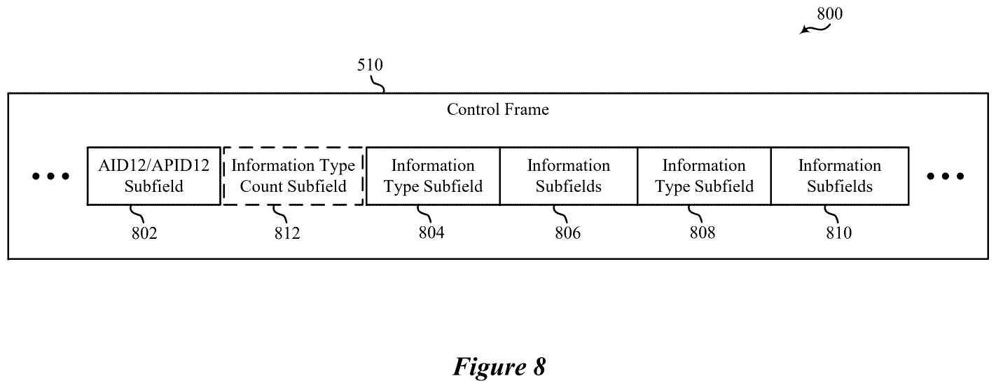

FIG. 8 shows example control frame format 800 that support unified ICF designs in accordance with conveying or supporting an information container. The control frame format 800 may implement or be implemented to realize one or more aspects of the wireless communication network 100, the control frame 200, the common information field 300, the user information field 400, or the signaling diagram 500. For example, the control frame 510 may be associated with the control frame format 800. In accordance with the control frame format 800, the control frame 510 may carry, indicate, include, or provide multiple information types, such as a first information type and a second information type.

In examples in which the control frame 510 is associated with the control frame format 800, the control frame 510 may include an AID12/APID12 subfield 802, an information type subfield 804, one or more information subfields 806, an information type subfield 808, and one or more information subfields 810. In such examples, the AID12/APID12 subfield 802 may indicate the identifier value 514, the information type subfield 804 may indicate a first information type 516, the one or more information subfields 806 may indicate first information 518 in accordance with the first information type 516, the information type subfield 808 may indicate a second information type 516, and the one or more information subfields 810 may indicate second information 518 in accordance with the second information type 516. In such examples, the information type subfield 804 and the one or more information subfields 806 may be associated with (included within) a first information container and the information type subfield 808 and the one or more information subfields 810 may be associated with (included within) a second information container. Alternatively, an information container within the control frame 510 may be understood as including multiple information types (the first information type 516 and the second information type 516).

In some examples, the information type subfield 804 and the information type subfield 808 may each include 4 bits. The one or more information subfields 806 and the one or more information subfields 810 may include a variable quantity of bits, such as in accordance with being associated with different information types 516. For example, for a given information type 516, there may be a fixed length of information-specific subfields. After the information-specific subfields, the wireless communication device 504 reading (such as parsing) the control frame 510 (such as the information container 512) may interpret a next 4 bits as indicative of a new or next information type 516, followed by the information specific subfields corresponding to the new or next information type 516.

In such examples of multiple information types within an information container or of multiple information containers within the control frame 510, each of the multiple information types may be intended for a same user. For example, two APs 102 may simultaneously perform C-TDMA+C-SR and, accordingly, first information associated with C-TDMA and second information associated with C-SR may be intended for a same AP 102. Additionally, or alternatively, a first set of the multiple information types 516 may be intended for a first user and a second set of multiple information types 516 may be intended for a second user. For example, a first AP 102 may perform C-TDMA with a second AP 102 while performing C-SR with a third AP 102. In such examples, first information 518 associated with C-TDMA may be intended for the second AP 102 and second information 518 associated with C-SR may be intended for the third AP 102. Wireless communication devices may determine for which information it is an intended receiver implicitly or explicitly. For example, the wireless communication device 504 may parse the control frame 510 (the information container 512) for one or more specific information types 516 that the wireless communication device 504 is interested in or may parse the control frame 510 (the information container 512) for an explicit indication that the wireless communication device 504 is intended to receive information 518 associated with one or more specific information types 516.

In some implementations, the control frame 510 may optionally include an information type count subfield 812. The information type count subfield 812 may follow (such as immediately follow) the AID12/APID12 subfield 802. The information type count subfield 812 may include a quantity of bits, such as 3 bits. In some aspects, the information type count subfield 812 may indicate a quantity of information types 516 present within the information container or may indicate a quantity of information containers included within the control frame 510. For example, the information type count subfield 812 may indicate that the control frame 510 includes a quantity of two information types 516 (in accordance with the control frame 510 including the information type subfield 804 and the information type subfield 808).

The AID12/APID12 subfield 802, the information type count subfield 812 (if included), the information type subfield 804, the one or more information subfields 806, the information type subfield 808, and the one or more information subfields 810 may be located within one or more fields of the control frame 510, such as in one or more of a common information field, one or more user information fields, or an information control field of the control frame 510. The AID12/APID12 subfield 802, the information type count subfield 812 (if included), the information type subfield 804, the one or more information subfields 806, the information type subfield 808, and the one or more information subfields 810 may be located consecutively or non-consecutively within the control frame 510. Further, the AID12/APID12 subfield 802, the information type count subfield 812 (if included), the information type subfield 804, the one or more information subfields 806, the information type subfield 808, and the one or more information subfields 810 may be located within a same field of the control frame 510 or may be distributed across multiple fields of the control frame 510.

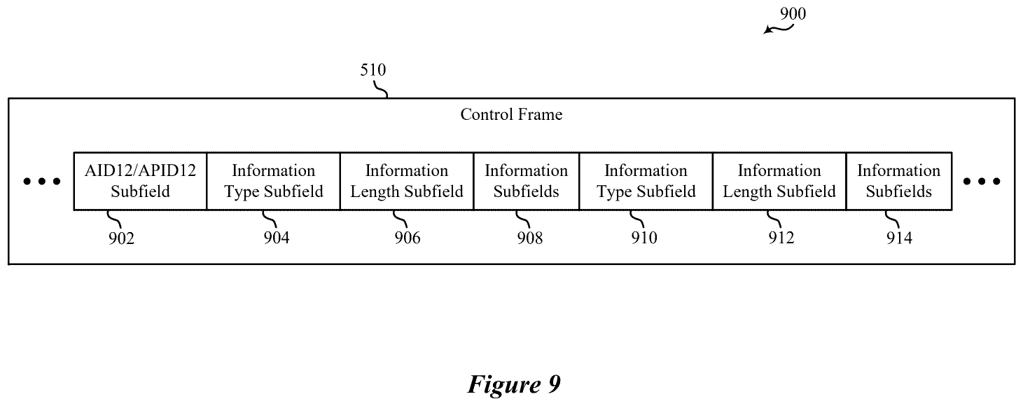

FIG. 9 shows an example control frame format 900 that supports unified ICF designs in accordance with conveying or supporting an information container. The control frame format 900 may implement or be implemented to realize one or more aspects of the wireless communication network 100, the control frame 200, the common information field 300, the user information field 400, or the signaling diagram 500. For example, the control frame 510 may be associated with the control frame format 900. In accordance with the control frame format 900, the control frame 510 may carry, indicate, include, or provide multiple information types, such as a first information type and a second information type.

In examples in which the control frame 510 is associated with the control frame format 900, the control frame 510 may include an AID12/APID12 subfield 902, an information type subfield 904, an information length subfield 906, one or more information subfields 908, an information type subfield 910, an information length subfield 912, and one or more information subfields 914. In such examples, the AID12/APID12 subfield 902 may indicate the identifier value 514, the information type subfield 904 may indicate a first information type 516, the information length subfield 906 may indicate a first length of the one or more information subfields 908, and the one or more information subfields 908 may indicate first information 518 in accordance with the first information type 516. The information type subfield 910 may indicate a second information type 516, the information length subfield 912 may indicate a second length of the one or more information subfields 914, and the one or more information subfields 914 may indicate second information 518 in accordance with the second information type 516.

In such examples, the information type subfield 904 and the one or more information subfields 908 may be associated with (included within) a first information container and the information type subfield 910 and the one or more information subfields 914 may be associated with (included within) a second information container. Alternatively, an information container within the control frame 510 may be understood as including multiple information types (the first information type 516 and the second information type 516). In some examples, the information type subfield 904 and the information type subfield 910 may each include a quantity of bits, such as 4 bits. In some examples, the information length subfield 906 and the information length subfield 912 may each include a quantity of bits, such as 3 bits.

The AID12/APID12 subfield 902, the information type subfield 904, the information length subfield 906, the one or more information subfields 908, the information type subfield 910, the information length subfield 912, and the one or more information subfields 914 may be located within one or more fields of the control frame 510, such as in one or more of a common information field, one or more user information fields, or an information control field of the control frame 510. The AID12/APID12 subfield 902, the information type subfield 904, the information length subfield 906, the one or more information subfields 908, the information type subfield 910, the information length subfield 912, and the one or more information subfields 914 may be located consecutively or non-consecutively within the control frame 510. Further, AID12/APID12 subfield 902, the information type subfield 904, the information length subfield 906, the one or more information subfields 908, the information type subfield 910, the information length subfield 912, and the one or more information subfields 914 may be located within a same field of the control frame 510 or may be distributed across multiple fields of the control frame 510.

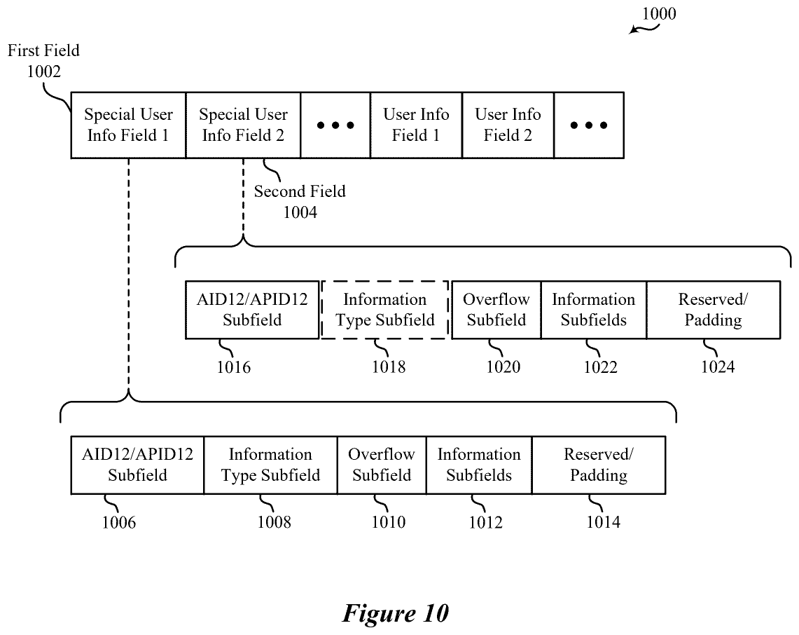

FIG. 10 shows an example user information field list 1000 that supports unified ICF designs in accordance with providing an information container via one or more special user information fields. The user information field list 1000 may implement or be implemented to realize one or more aspects described herein. For example, the wireless communication device 502 and the wireless communication device 504 may leverage the user information field list 1000 in accordance with using one or multiple user information fields to carry the information container 512. For example, the wireless communication device 502 and the wireless communication device 504 may use one or more special user information fields of the control frame 510 to convey additional common information that is unable to fit within a common information field of the control frame 510 (as the common information field of the control frame 510 may include a relatively small quantity of available (such as reserved) bits in scenarios in which the control frame 510 solicits a TB PPDU response in, for example, an MU case).

In some aspects, the information container may additionally include an indication of whether a single field (such as a single user information field) carries the information container or of whether the contents of the information container are spread or distributed across at least two fields. Such an indication may take one of various forms. In some examples, and as illustrated in the example of FIG. 10, the indication may take the form of a single bit, which may be understood as an overflow bit (conveyed by, for example, an overflow subfield).

A length of a user information field (such as a special user information field) may be 40 bits. Accordingly, if an AID12/APID12 subfield of 12 bits, an information type subfield of 4 bits, and an overflow subfield of 1 bit are present within an information container, up to 23 bits may be available for a set of one or more information subfields within the user information field. If the information provided via the information container exceeds 23 bits, the information may be partitioned such that a first portion of the information is included within a first user information field and a second portion of the information is included within a second (such as subsequent, such as immediately subsequent) user information field. If the information is unable to fit within the first and second user information fields, a third portion of the information may be included within a third (such as subsequent, such as immediately subsequent) user information field, and so on.

In scenarios in which the information is spread out across multiple fields (such as multiple special user information fields), the overflow subfield may indicate a presence of an additional field (such as an additional special user information field) for that information type. For example, within a first field, an overflow bit value of “1” may indicate the presence of at least a second (special user information) field for that same (the previously indicated) information type and an overflow bit value of “0” may indicate that no additional (special user information) fields are present for that same (the previously indicated) information type.

For example, a first field 1002 (such as a first special user information field) may include an AID12/APID12 subfield 1006 indicative of an identifier value 514, an information type subfield 1008 indicative of an information type 516, an overflow subfield 1010, one or more information subfields 1012 indicative of information 518 in accordance with the indicated information type 516, and (optionally) a reserved/padding subfield 1014. In examples in which the one or more information subfields 1012 are insufficient to convey an entirety of the information 518, the overflow subfield 1010 may indicate that a second field 1004 (such as a second, subsequent special user information field) includes a second portion of the information 518.

The second field 1004 (the second, subsequent special user information field) may include an AID12/APID12 subfield 1016 indicative of the identifier value 514, (optionally) an information type subfield 1018 indicative of the information type 516, an overflow subfield 1020, one or more information subfields 1022 indicative of the second portion of the information 518, and (optionally) a reserved/padding subfield 1024. In some aspects, the second field 1004 may include the same AID12/APID12 subfield value (the same identifier value 514) as the first field 1002. In examples in which the second field 1004 is a last or final special user information field pertaining to the information type 516 indicated at least by the information type subfield 1008, the overflow subfield 1020 may indicate that no additional (special user information) fields are present for that same (the previously indicated) information type.

In some examples, the second field 1004 may have a same structure or format as the first field 1002, such as the same sequence of AID12/APID12, information type, overflow, and continuing information subfields. In such examples, the information type subfield 1018 may indicate the same information type 516 as the information type subfield 1008. In other words, the information type is the same as the special user information field in which the first bit of the information subfields resides. In some other examples, the second field 1004 may have a different structure or format as compared to the first field 1002. For example, the second field 1004 may exclude the information type subfield 1018 (as it may be implied that the one or more information subfields 1022 indicate the second portion of the information 518 associated with the previously indicated information type 516 in accordance with the previous field indicating the overflow state). In examples in which the second field 1004 excludes the information type subfield 1018, the one or more information subfields 1022 of the second field 1004 may occupy up to 27 bits (as the 3 bits used by the information type subfield 1008 in the first field 1002 may be available for conveying information 518 in the second field 1004). Otherwise, if the information type subfield 1018 is included, the one or more information subfields 1022 may occupy up to 23 bits.

In some aspects, the wireless communication device 502 may include the reserved/padding subfield 1014 or the reserved/padding subfield 1024, or both, to set an overall or total length of the first field 1002 and the second field 1004 to a specific quantity of bits (such as 40 bits in examples in which the first field 1002 and the second field 1004 are special user information fields). For example, the unused bits from a last special user information field (a last field carrying the information 518) may be reserved. The reserved/padding subfield 1014 may include padding bits, reserved bits, or any combination thereof. The reserved/padding subfield 1024 may include padding bits, reserved bits, or any combination thereof. In some aspects, a length of the reserved/padding subfield 1014 may depend at least on a length of the one or more information subfields 1012 and length of the reserved/padding subfield 1024 may depend at least on a length of the one or more information subfields 1022.

Further, although an example order of user information fields is illustrated by FIG. 10, other orders of user information fields are within the scope of the present disclosure. In some implementations, for example, the wireless communication device 502 may order the user information field list 1000 such that user information fields including AID12/APID12 subfield values greater than 2007 (such as AID12/APID12 subfield values within an inclusive range of between 2008 and 2044 or between 2047 and 4094) are located after user information fields including AID12/APID12 subfield values in an inclusive range of between 1 and 2007. In some aspects, such as ordering may be in accordance with a rule, such as a rule that is enabled, activated, or applicable in scenarios in which the control frame 510 addresses at least one wireless communication device incapable of parsing, recognizing, or understanding an information container 512. Such an ordering or rule may support backward and forward compatibility of the control frame 510.

Additionally, or alternatively, the wireless communication device 502 may refrain from addressing a wireless communication device incapable of parsing, recognizing, or understanding an information container 512 when the control frame 510 includes an information container 512. Additionally, or alternatively, the wireless communication device 502 may order the user information field list 1000 such that user information fields including AID12/APID12 subfield values within an inclusive range of between 2008 and 2044 or between 2047 and 4094 are located after a field including an AID12/APID12 subfield value of 4095. For example, the wireless communication device 502 may order the user information field list 1000 such that user information fields including AID12/APID12 subfield values within an inclusive range of between 2008 and 2044 or between 2047 and 4094 are located after padding.

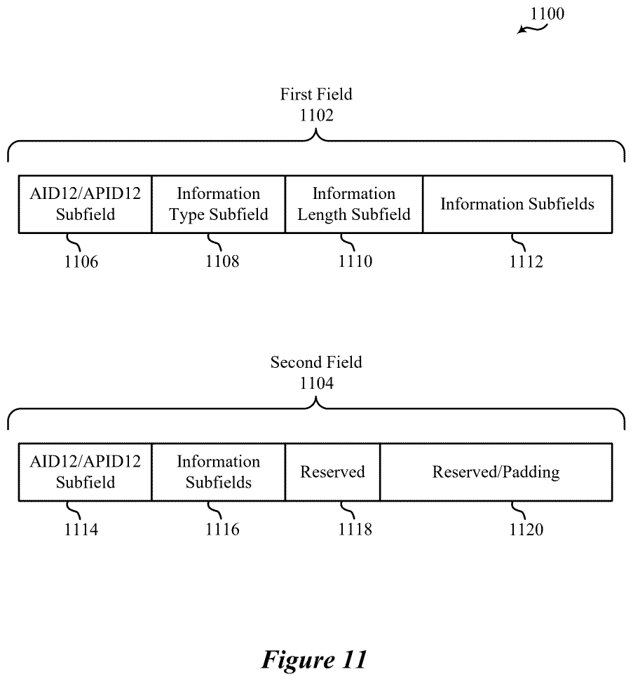

FIG. 11 shows an example field sequence 1100 illustrating a distribution of information subfields across multiple fields that supports unified ICF designs. The field sequence 1100 may implement or be implemented to realize one or more aspects described herein. For example, the wireless communication device 502 and the wireless communication device 504 may leverage the field sequence 1100 in accordance with using multiple (user information) fields to carry an information container 512 (such that the information container 512 may be understood as a multi-field information container). For example, the information container 512 may be distributed across a first field 1102 (such as a first special user information field) and a second field 1104 (such as a second, subsequent special user information field). The field sequence 1100 illustrates examples in which, instead of an “overflow bit,” the information container 512 may include an information length subfield to indicate a length of the information subfields for a given information type.

For example, the first field 1102 may include an AID12/APID12 subfield 1106 indicative of an identifier value 514, an information type subfield 1108 indicative of an information type 516, an information length subfield 1110, and one or more information subfields 1112 indicative of information 518 associated with the information type 516. The information length subfield 1110 may indicate a length or size of the information 518, such as a quantity of octets or bits, or any combination thereof, to carry or accommodate the information 518. In accordance with the indicated length or size of the information 518, the wireless communication device 502 and the wireless communication device 504 may determine a quantity of fields (such as a quantity of special user information fields) that carry the information 518. The information length subfield 1110 may be a quantity of bits, such as 3 bits.

For example, if the information 518 is associated with a size of 26 bits, two fields may be used to carry the information 518, and the information length subfield 1110 may indicate a bit value (of, for example, “101”) to indicate a length of the information 518 to be 4 octets. In such an example, a first portion (such as a first 21 bits) of the information 518 may be within the one or more information subfields 1112 of the first field 1102 and a second portion (such as a second, and remaining, 5 bits) of the information 518 may be within one or more information subfields 1116 within the second field 1104. In some aspects, a quantity of unused bits (such as 6 unused bits in the example of the information 518 being 26 bits) within a final or last octet (such as the fourth octet) carrying the information 518 may be reserved. The reserved bits may be understood as being within a reserved subfield 1118.

The second field 1104, which may immediately follow the first field 1102, also may include an AID12/APID12 subfield 1114, which may indicate the same identifier value 514 as the subfield 1106. In some examples, the second field 1104 may include a reserved/padding subfield 1120, a length of which may depend at least on a length of the one or more information subfields 1116 and the reserved subfield 1118. In the example in which the information 518 includes 26 bits, the reserved/padding subfield 1120 may include 17 bits.

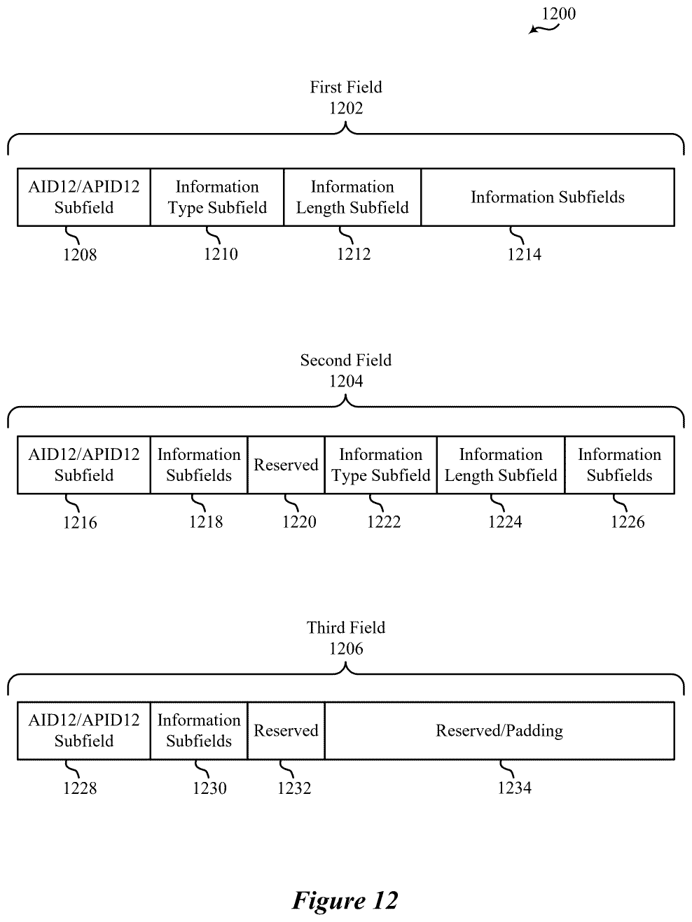

FIG. 12 shows an example field sequence 1200 illustrating a distribution of information subfields across multiple fields that supports unified ICF designs. The field sequence 1200 may implement or be implemented to realize one or more aspects described herein. For example, the wireless communication device 502 and the wireless communication device 504 may leverage the field sequence 1200 in accordance with using multiple (special user information) fields to carry an information container 512. In the example of the field sequence 1200, the information container 512 may include multiple information types 516. In other words, the field sequence 1200 illustrates an example in which the information container 512 includes multiple information types 516 and according to which multiple information types are concatenated across multiple fields, such as across a first field 1202, a second field 1204, and a third field 1206 (which may be examples of three consecutive special user information fields).

The first field 1202 may include an AID12/APID12 subfield 1208 indicative of an identifier value 514, an information type subfield 1210 (of, for example, 4 bits) indicative of a first information type 516, an information length subfield 1212 (of, for example, 3 bits) indicative of a length associated with first information 518 associated with the first information type 516, and one or more information subfields 1214 indicative of a first portion of the first information 518. The second field 1204 may include a second portion of the first information 518 in accordance with the information length subfield 1212 indicating a quantity of octets or a quantity of bits, or any combination thereof, that exceed a space available within the first field 1202, as described with reference to FIG. 11.

The second field 1204 may include an AID12/APID12 subfield 1216 indicative of the identifier value 514, one or more information subfields 1218 indicative of the second portion of the first information 518, and a reserved bits subfield 1220 of a variable quantity of bits (depending on a quantity of unused bits within a final octet carrying the first information 518). In some examples, the first information 518 may be associated with a length of 26 bits (which 4 octets may accommodate). In such examples, the one or more information subfields 1214 may span 21 bits, the one or more information subfields 1218 may span 5 bits, and the reserved bits subfield 1220 may include 6 bits. In some implementations, the second field 1204 may additionally include second information 518 associated with a second information type 516. In such implementations, the second field 1204 may include an information type subfield 1222 (of, for example, 4 bits) indicative of the second information type 516, an information length subfield 1224 (of, for example, 3 bits) indicative of a length associated with the second information 518, and one or more information subfields 1226 indicative of (at least) a first portion of the second information 518. In some examples, the length associated with the second information 518 may be 20 bits (which 3 octets may accommodate) and, in such examples, the third field 1206 may include a second portion of the second information 518. In some examples, the one or more information subfields 1226 may include 10 bits of the second information 518.

The third field 1206 may include an AID12/APID12 subfield 1228 indicative of the identifier value 514, one or more information subfields 1230 indicative of the second portion of the second information 518, a reserved bits subfield 1232, and a reserved/padding subfield 1234. The reserved bits subfield 1232 may include a variable quantity of bits depending on a quantity of unused bits within a final octet carrying the second information 518. In examples in which the one or more information subfields 1230 include 10 bits of the information 518, the reserved bits subfield 1232 may include 4 bits. In such examples, the reserved/padding subfield 1234 may include 14 bits.

In some implementations, the wireless communication device 502 or the wireless communication device 504, or both, may support one or more rules associated with including multiple information types 516 within a same field (such as within a same special user information field). For example, the wireless communication device 502 may determine whether to include the one or more information subfields 1226 indicative of the second information 518 within the second field 1204 in accordance with a rule, such as in accordance with a satisfaction of a criterion. In some aspects, the wireless communication device 502 may include the one or more information subfields 1226 indicative of the second information 518 within the second field 1204 in accordance with a quantity of remaining bits within the second field 1204, after inclusion of the one or more information subfields 1218 indicating the first information 518 (potentially among other subfields within the second field 1204), satisfying a threshold quantity of bits.

For example, if the quantity of remaining bits is greater than a threshold quantity of bits (such as 10 bits), the wireless communication device 502 may include the one or more information subfields 1226 within the second field 1204. Otherwise, if the quantity of remaining bits is less than or equal to the threshold quantity of bits, the wireless communication device 502 may exclude the one or more information subfields 1226 and start including the second information 518 within the third field 1206 (such as the next special user information field). In examples in which the wireless communication device 502 excludes the one or more information subfields 1226 from the second field 1204, the second field 1204 may instead include a reserved/padding subfield.

In some implementations, the wireless communication device 502 may order the first information type 516 and the second information type 516 within the first field 1202, the second field 1204, and the third field 1206 in accordance with a rule. For example, in examples in which multiple information types 516 are considered or included within an information container 512, an order of the information types 516 may be selected, decided, or determined in accordance with a degree of time sensitivity of a corresponding signaling type or functionality. For example, a dynamic puncturing signaling type or functionality may be relatively more time sensitive than one or more other signaling types or functionalities and, accordingly, may be ordered relatively earlier (such as first) within a set of multiple information types 516. In other words, an initial information type 516 within an information container 512 may pertain to dynamic puncturing. Generally, information pertaining to relatively more time sensitive signaling types may be located relatively earlier within a set of information types 516 and information pertaining to relatively less time sensitive signaling types may be located relatively later within the set of information types 516. Such an order may be in accordance with a standard or network specification (and statically configured at the wireless communication device 502 or the wireless communication device 504, or both), may be associated with device decision, or a combination thereof. In some examples, two or more wireless communication devices may coordinate or negotiate on the order.

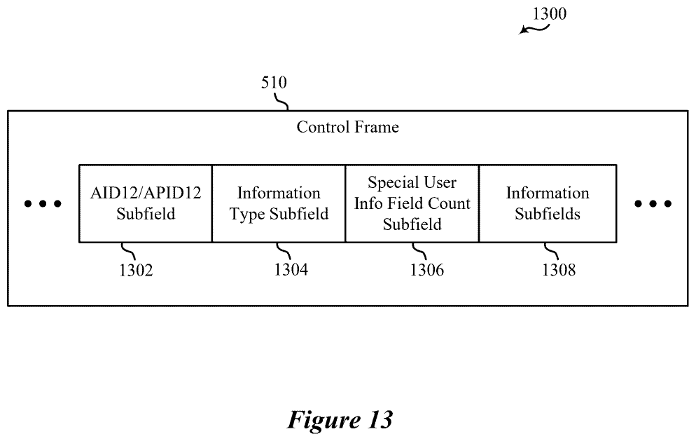

FIG. 13 shows an example control frame format 1300 that supports unified ICF designs in accordance with conveying or supporting an information container. The control frame format 1300 may implement or be implemented to realize one or more aspects described herein. For example, the control frame 510 may be associated with the control frame format 1300. In accordance with the control frame format 1300, the control frame 510 may include a special user information field count subfield, such as instead of an overflow bit or subfield.

For example, the control frame 510 may include an AID12/APID12 subfield 1302 indicative of an identifier value 514, an information type subfield 1304 indicative of an information type 516, a special user information field count subfield 1306, and one or more information subfields 1308 indicative of information 518 associated with the information type 516. The special user information field count subfield 1306 may indicate a quantity of special user information fields that include or carry the information 518 associated with the information type 516 indicated by the information type subfield 1304.

In some implementations, the information container 512 for a common information field may indicate the quantity of special user information fields for a given (such as for a same) information type via the special user information field count subfield 1306. In other words, a common information field of the control frame 510 may include, carry, provide, or indicate the special user information field count subfield 1306. Additionally, or alternatively, a first or initial special user information field may include, carry, provide, or indicate the special user information field count subfield 1306 for the same information type 516. In such implementations, the special user information field count subfield 1306 may indicate a quantity of subsequent special user information fields, after the first or initial special user information field, that include or carry the information 518 associated with the information type 516 indicated by the information type subfield 1304. The subsequent special user information fields may include or may exclude a special user information field count subfield 1306 indicative of a quantity of subsequent special user information fields that include or carry the information 518.

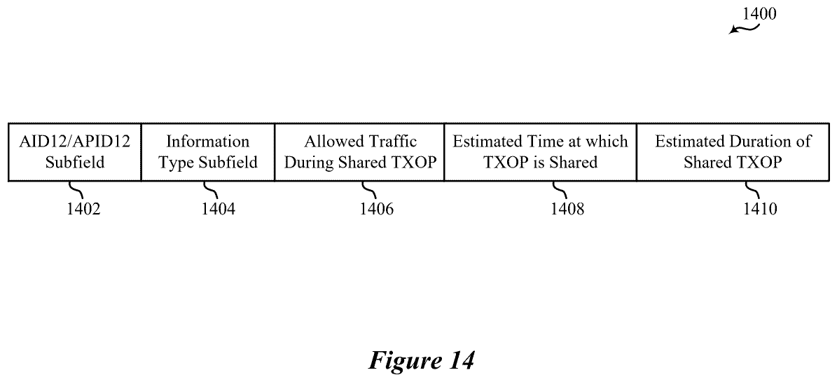

FIG. 14 shows an example information container 1400 associated with various signaling types that supports unified ICF designs. The information container 1400 may indicate example contents of an information container 512 in implementations in which an indicated information type 516 corresponds to a C-TDMA signaling type or functionality.

To facilitate C-TDMA, a schedule announcement frame may be, act as, or function as a control frame 510 (such as an ICF) and may indicate information to candidate shared devices (such as candidate shared APs 102). Such information is illustrated by Table 1, shown below.

TABLE 1
C-TDMA Information

| | Frame to signal the |
|---|---|
| Information to be indicated | information |
| Traffic category or traffic flow for which | Schedule Announcement/ |
| a shared AP can use the TXOP: AC, TID, | TXOP Allocation |
| SCSID (10 bits) | |
| Estimated time when the TXOP will be | Schedule Announcement |
| shared (3-6 bits depending on encoding) | |
| Estimated duration of the shared TXOP | Schedule Announcement |
| (3-6 bits depending on encoding) | |

As an example of information indicative of a traffic category or a traffic flow for which a shared AP 102 can use a shared TXOP, if the sharing AP 102 shares the TXOP exclusively for AC_VO traffic, the C-TDMA information may include a bit sequence of 01 00000011, where the first “01” may indicate “AC” and the second “00000011” may indicate VO (voice) traffic. Other allowed traffic classifiers include “no priority” (which may correspond to a bit mapping of “00”), “TID” which may correspond to a bit mapping of “10”), and SCSID (which may correspond to a bit mapping of “11”). In some aspects, even with shortened SCSIDs, C-TDMA information (such as information 518 when the information type 516 corresponds to C-TDMA) may include at least 12 bits of information. In other words, at least 12 bits of information may be sent via the control frame 510 (an ICF for schedule announcement).

Thus, to convey such information, the control frame 510 may include, within the information container 1400, an AID12/APID12 subfield 1402 indicative of an identifier value 514, an information type subfield 1404 indicative of C-TDMA, and information 518 that includes one or more of an indication 1406 of an allowed traffic during a shared TXOP (10 bits), an indication 1408 of an estimated time at which a TXOP is to be shared (4 bits), and an indication 1410 of an estimated duration of the shared TXOP (4 bits). The indication 1406 of an allowed traffic during a shared TXOP, the indication 1408 of an estimated time at which a TXOP is to be shared, and the indication 1410 of an estimated duration of the shared TXOP may be information-specific subfields for C-TDMA (C-TDMA information). Each of such indications may be associated with (such as located within or indicated by) a corresponding information subfield. The information container 1400 may be included within one or more fields, such as within a common information field, one or more user information fields, an information control field, or any combination thereof.

Additionally, or alternatively, a (normal) user information field may include C-TDMA-specific information. For example, such a user information field may include an AID12/APID12 subfield, a subfield indicative of a quantity of additional user information fields with a same AID12/APID12 (3 or 4 bits), and one or more subfields indicative of the C-TDMA information.

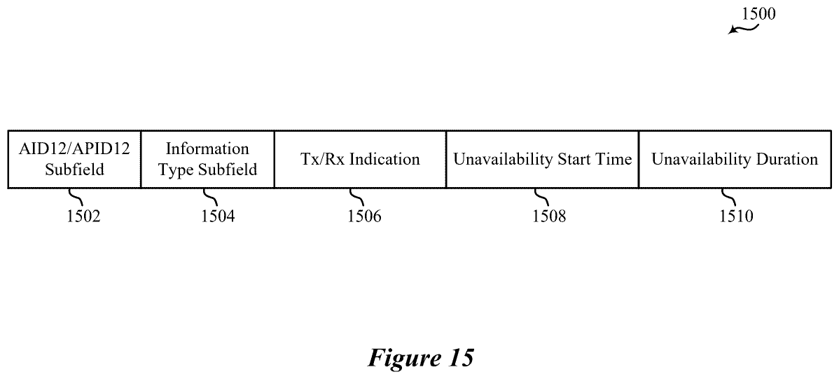

FIG. 15 shows an example information container 1500 associated with various signaling types that supports unified ICF designs. The information container 1500 may indicate example contents of an information container 512 in implementations in which an indicated information type 516 corresponds to a CoEx signaling type or functionality.

A CoEx signaling type or functionality may enable a device (such as a STA 104) to unsolicitedly (such as without receiving a request or solicitation) share its future unavailability information to one or more peer devices (such as peer STAs 104). The control frame 510 may be used to convey such information, with such information that a device may share including a transmit/receive (Tx/Rx) indication to specify whether the unavailability information included in the frame is relevant to transmission only, reception only, or both; an unavailability period start time indicating when the device may start being unavailable in the future; and an unavailability period duration indicating for how long the device may be unavailable.

Thus, to convey such information, the control frame 510 may include, within the information container 1500, an AID12/APID12 subfield 1502 indicative of an identifier value 514 (12 bits), an information type subfield 1504 indicative of CoEx signaling (4 bits), and information 518 that includes one or more of a Tx/Rx indication 1506 (2 bits), an indication 1508 of an unavailability start time (8 bits), and an indication 1510 of an unavailability duration (8 bits). The Tx/Rx indication 1506, the indication 1508 of an unavailability start time, and the indication 1510 of an unavailability duration may information-specific subfields for CoEx (CoEx information). Each of such indications may be associated with (such as located within or indicated by) a corresponding information subfield.

Depending on which format or structure the information container 1500 is associated with, the information container 1500 may include a 1-bit overflow subfield or a 4-bit length subfield, among other examples as disclosed herein. The information container 1500 may be included within one or more fields, such as within a common information field, one or more user information fields, an information control field, or any combination thereof. The information container 1500 may include padding of variable length depending on whether there is another information type-specific information included before the CoEx information. Additionally, or alternatively, if there is other information type-specific information to be added after the CoEx information, padding may be replaced with such other information.

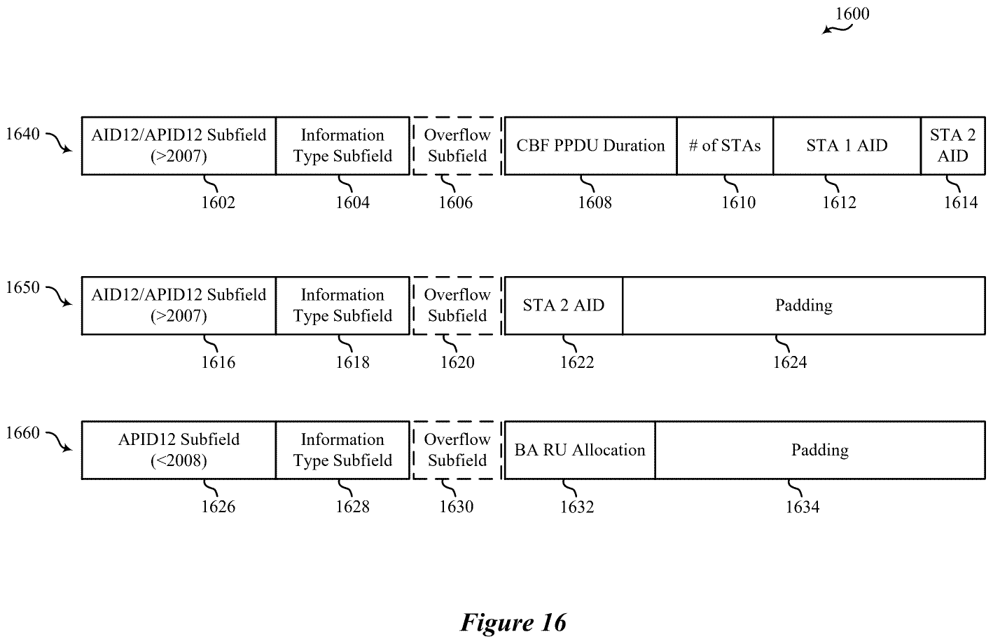

FIG. 16 shows an example field sequence 1600 associated with various signaling types that supports unified ICF designs. The field sequence 1600 may indicate example contents of an information container 512 in implementations in which an indicated information type 516 corresponds to a CBF signaling type or functionality. The field sequence 1600 may include multiple fields, such as a first field 1640, a second field 1650, and a third field 1660, in examples in which CBF information is unable to fit within a single field, such as within a single special user information field. The first field 1640 and the second field 1650 may be examples of special user information fields (AID12 value greater than 2007) and the third field 1660 may be an example of a (normal or regular) user information field (AID12 value between 1 and 2007).

In some aspects, a CBF Trigger frame may be sent to indicate a sharing device's (AP's) willingness to share its TXOP with a shared device (a shared AP 102) and to share some information associated with the TXOP sharing. Such information may include a CBF PPDU duration indicative of how long a CBF PPDU may be for the shared device to align its CBF, a quantity of STAs 104 the sharing device schedules during the CBF TXOP, a quantity of STA IDs equal to the quantity of STAs 104 the sharing device schedules during the CBF TXOP, the shared device (the shared AP 102) AID (APID12) to indicate shared device-specific information, and block acknowledgment (BA) RU allocation indicating an RU assigned for the shared device's associated clients to send BA response frames.

To convey such information, the control frame 510 may include, within one or multiple information containers, an AID12/APID12 subfield indicative of an identifier value 514, an information type subfield 1504 indicative of CBF signaling, and information 518 indicative of one or more of an indication of a CBF PPDU duration, an indication of a quantity of STAs, an indication of one or more STA AID values corresponding to the quantity of STAs, indication of a shared AP AID, and an indication of a BA RU allocation. In the example of the field sequence 1600, such information may be distributed across multiple fields.

The first field 1640 may include an AID12/APID12 subfield 1602 indicative of an identifier value 514 (12 bits), an information type subfield 1604 indicative of CBF signaling (4 bits), (optionally) an overflow subfield 1606 (1 bit), an indication 1608 of a CBF PPDU duration (8 bits), an indication 1610 of a quantity of STAs (2 bits), an indication 1612 of a STA 1 AID (12 bits), and a first portion 1614 of an indication of a STA 2 AID (1 bit). The second field 1650 may include AID12/APID12 subfield 1616 indicative of the identifier value 514 (12 bits), optionally an information type subfield 1618 indicative of CBF signaling (4 bits), optionally an overflow subfield 1620 (1 bit), a second portion 1622 of the STA 2 AID (11 bits), and a padding subfield 1624 (a variable quantity of bits). The padding may be of variable length depending on whether there is other information type-specific information included prior to or after the CBF information. The information associated with CBF may not fit within a single special user information field, such that two consecutive special user information fields may carry the information associated with CBF. Depending on which format or structure the information container is associated with, the information container may include a 1-bit overflow subfield or a 4-bit length subfield, among other examples as disclosed herein.

The third field 1660, which may be an example of a normal user information field, may include an APID12 subfield 1626 indicative of an identifier value less than 2008 (such as an identifier value that corresponds to the shared AP AID) (12 bits). The third field 1660 may include an information type subfield 1628 indicative of CBF (4 bits), optionally an overflow subfield 1630 (1 bit), an indication 1632 of a BA RU allocation (8 bits) for the shared AP 102, and a padding subfield 1634 (a variable quantity of bits). In some implementations, the third field 1660 may exclude the information type subfield 1628 and the overflow subfield 1620 and may instead include one or more other fields, such as fields included within user information fields associated with AIDs between 1 and 2007. In some examples, the field sequence 1600 may include additional user information fields indicating a respective BA RU allocation for each of potentially multiple shared APs 102.

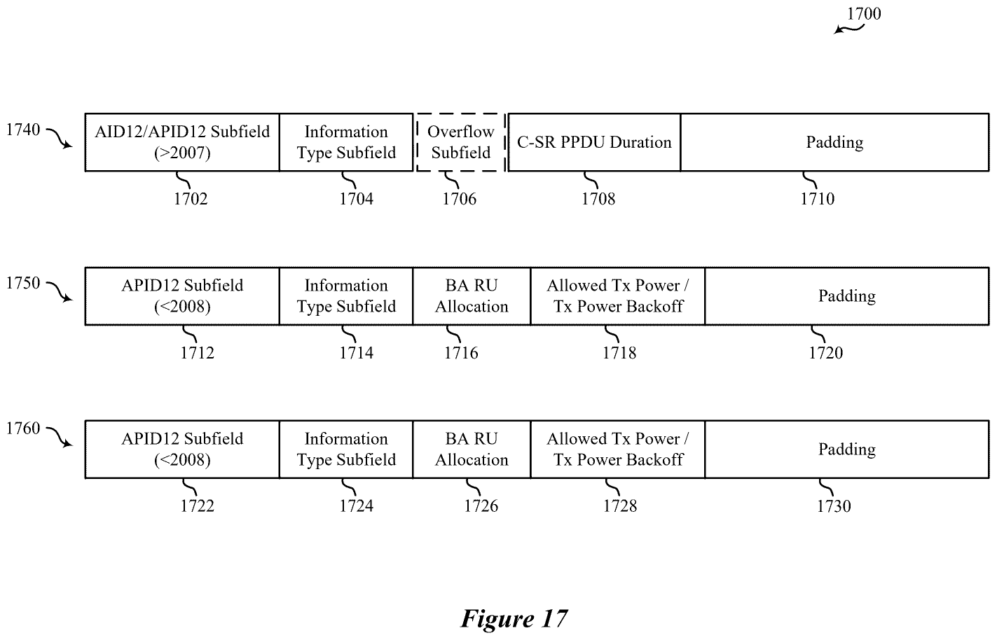

FIG. 17 shows an example field sequence 1700 associated with various signaling types that supports unified ICF designs. The field sequence 1700 may indicate example contents of an information container 512 in implementations in which an indicated information type 516 corresponds to a C-SR signaling type or functionality. The field sequence 1700 may include multiple fields, such as a first field 1740, a second field 1750, and a third field 1760, in examples in which C-SR information is unable to fit within a single field, such as within a single special user information field. The first field 1740 may be an example of a special user information fields (AID12 value greater than 2007) and the second field 1750 and the third field 1760 may be examples of (normal or regular) user information fields (AID12 value between 1 and 2007).

In some aspects, a CBF Trigger frame may be sent to indicate a sharing device's (such as an AP's) willingness to share its TXOP with a shared device (a shared AP 102) and to share some information associated with the TXOP sharing. Such information may include an indication of a CAP scheme to indicate that the information included in the control frame 510 is related to CBF operation, a C-SR PPDU duration to indicate how long a C-SR PPDU may be for the shared AP 102 to align its C-SR PPDU with a sharing AP's PPDU, a shared AP AID (such as an APID12) to indicate shared AP-specific information, a BA RU allocation to indicate an RU assigned for the shared AP's associated clients to send their BA response frames, and an allowed transmit (Tx) power (or a transmit power backoff) to dictate an allowed Tx power to each shared AP separately.

To convey such information, the control frame 510 may include, within one or multiple information containers, an AID12/APID12 subfield indicative of an identifier value 514, an information type subfield 1504 indicative of C-SR signaling, and information 518 indicative of one or more of a C-SR PPDU duration, one or more shared AP AIDs, one or more BA RU allocations, and one or more allowed Tx powers (or a transmit power backoffs). In the example of the field sequence 1700, such information may be distributed across multiple fields. For example, such C-SR information may be reported via a special user information field (such as the first field 1740) and one or multiple normal user information fields (such as the second field 1750 and the third field 1760).

For example, the first field 1740 may include an AID12/APID12 subfield 1702 indicative of the identifier value 514 (12 bits), an information type subfield 1704 indicative of C-SR (4 bits), optionally an overflow subfield 1706 (1 bit), an indication 1708 of a C-SR PPDU duration (8 bits), and a padding subfield 1710 (variable quantity of bits). Depending on which format or structure the information container is associated with, the information container may include a 1-bit overflow subfield or a 4-bit length subfield, among other examples as disclosed herein. The padding may be of variable length depending on whether there is other information type-specific information included prior to or after the C-SR information. For example, padding may be replaced with other information type-specific information, if another information type is provided via the first field 1740.

The second field 1750 may include an APID12 subfield 1712 indicative of an identifier value less than 2008 (such as an identifier value that corresponds to a first shared AP AID) (12 bits), optionally an information type subfield 1714 indicative of C-SR (4 bits), a BA RU allocation subfield 1716 (8 bits), and an allowed Tx power/Tx power backoff subfield 1718 (6 bits), and a padding subfield 1720 (variable quantity of bits). The third field 1760 may include an APID12 subfield 1722 indicative of an identifier value less than 2008 (such as an identifier value that corresponds to a second shared AP AID) (12 bits), optionally an information type subfield 1724 indicative of C-SR (4 bits), a BA RU allocation subfield 1726 (8 bits), an allowed Tx power/Tx power backoff subfield 1728 (6 bits), and a padding subfield 1730 (variable quantity of bits). In some implementations, the second field 1750 and the third field 1760 may exclude an information type subfield and may instead include one or more other fields, such as fields included within user information fields associated with AIDs between 1 and 2007. In accordance with the second field 1750 and the third field 1760, a normal user information field may be used to report the BA RU allocation and (upper limit or maximum) allowed transmit power or transmit power backoff value for each of one or more shared APs 102. In some aspects, each shared AP 102 is addressed by an APID12 value which is assigned to that shared AP 102 by the sharing AP 102 at the stage of establishing the C-SR relationship between the sharing AP 102 and the shared AP(s) 102.

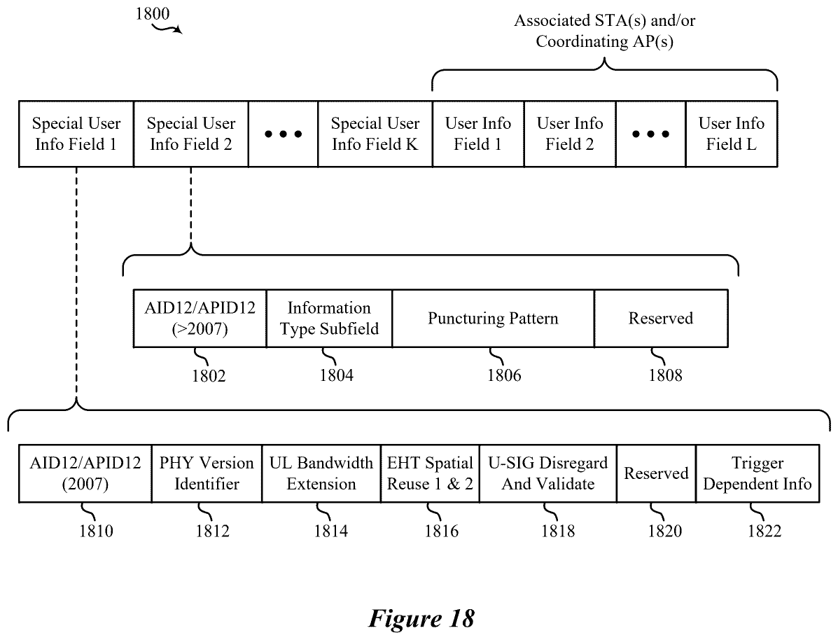

FIG. 18 shows an example user information field list 1800 associated with various signaling types that supports unified ICF designs. The user information field list 1800 may indicate example contents of an information container 512 in implementations in which an indicated information type 516 corresponds to a dynamic puncturing signaling type or functionality.

In examples in which a device (such as a STA 104) transmits a PPDU via a bandwidth greater than 20 MHz, the device may dynamically puncture one or more 20 MHz subchannels in the PPDU. By puncturing one or more subchannels, the device implies that it does not transmit energy on the subchannel(s). Such puncturing may be performed to avoid dynamic interference within a PPDU/operating bandwidth. For example, a 320 MHz bandwidth may have interference in an 80 MHz portion. Puncturing may enable one or more devices to avoid transmitting in that 80 MHz and use the remaining 240 MHz.

In examples in which a TXOP holder punctures one or more subchannels within a PPDU bandwidth, a TXOP responder also may puncture the same one or more subchannels. Thus, a TXOP holder (and sharing device) may include an indication of a puncturing pattern within the TXOP holder's PPDU, such that the TXOP responder may replicate the indicated puncturing pattern. Some networks, however, may lack provisions for indicating a puncturing pattern when a PPDU is a non-HT duplicate PPDU. The control frame 510 may be associated with a non-HT duplicate PPDU format. In some implementations, the control frame 510 may indicate (such as signal) the puncturing pattern used so that a responder, in a response frame (such as the control response frame 520), may replicate the puncturing pattern.

In such implementations, a special user information field may include an AID12/APID12 subfield 1802 indicative of an identifier value 514 (12 bits), an information type subfield 1804 indicative of an information type 516 corresponding to dynamic puncturing (4 bits), a puncturing pattern subfield 1806 (5 or 16 bits), and a reserved bits subfield 1808 (variable quantity of bits). In some aspects, another special user information field may include an AID12/APID12 subfield 1810 indicative of an identifier value of 2007, a PHY version identifier subfield 1812, an uplink bandwidth extension subfield 1814, one or more EHT spatial reuse subfields 1816 (such as an EHT spatial reuse 1 subfield and an EHT spatial reuse 2 subfield), a U-SIG disregard and validate subfield 1818, a reserved bits subfield 1820, and a trigger dependent information subfield 1822.

The puncturing pattern subfield 1806 may indicate a puncturing pattern in one or more of various ways. In some implementations, the puncturing pattern subfield 1806 may signal the puncturing pattern via a bitmap. In such implementations, two octets may be used to signal the puncturing pattern. From the least significant bit (LSB) to the most significant bit (MSB), the bits indicate whether a corresponding 20 MHz subchannel within the BSS bandwidth is punctured or not. For example, a lowest numbered bit may correspond to the 20 MHz subchannel that lies within the BSS bandwidth and is the lowest in frequency of the set of all 20 MHz subchannels within the BSS bandwidth. Each successive bit in the bitmap may correspond to the next higher frequency 20 MHz subchannel. A bit in the bitmap and that lies within the BSS bandwidth may be set to 1 to indicate that the corresponding 20 MHz subchannel is punctured and may be set to 0 to indicate that the corresponding 20 MHz subchannel is not punctured. A bit in the bitmap that falls outside of the BSS bandwidth may be reserved. For example, a bitmap may be set to 0000 0000 0000 1111 if the upper 80 MHz (in frequency domain) of the PPDU/operating/BSS bandwidth is punctured. In some other implementations, the puncturing pattern subfield 1806 may signal the puncturing pattern via an encoded value that corresponds to the puncturing pattern. For example, the puncturing pattern subfield 1806 may include 5 bits to signal a value between 0 and 24 that indicates the puncturing pattern, such as in accordance with a mapping or correspondence (as defined by, for example, a table).

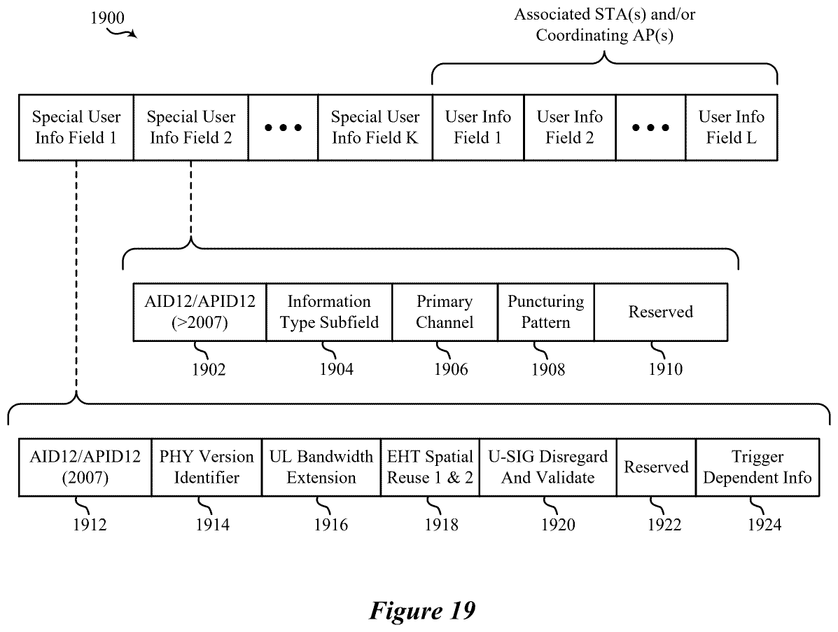

FIG. 19 shows an example user information field list 1900 associated with various signaling types that supports unified ICF designs. The user information field list 1900 may indicate example contents of an information container 512 in implementations in which an indicated information type 516 corresponds to an NPCA signaling type or functionality.

In examples in which an NPCA device (such as an NPCA STA) transmits a PPDU via an opportunistic primary (O-Primary, or NPCA primary) channel, the device may indicate a puncturing pattern used in the PPDU and which primary channel (such as which primary subchannel) was used to transmit the PPDU. In some aspects, puncturing may be expected in NPCA in scenarios in which an OBSS transmission bandwidth is such that a remaining bandwidth is not 20, 40, 80, or 160 MHz. For example, if the BSS bandwidth is 320 MHz and the OBSS bandwidth is 160 MHz, an entire remaining (160 MHz) bandwidth may be sued without puncturing. By way of further example, if the OBSS bandwidth is 40 MHz, to utilize an entire remaining bandwidth (280 MHz), one or more devices may use subchannel puncturing.

Thus, an NPCA ICF (the control frame 510) may indicate a puncturing pattern such that a TXOP responder on the O-Primary channel may replicate the puncturing pattern and avoid interfering with the OBSS transmission on the main primary (M-Primary) channel. Additionally, or alternatively, the NPCA ICF (the control frame 510) may include an explicit indication that the ICF is sent via the O-Primary channel. Without this indication, there may be an ambiguity on whether the frame was sent via the M-Primary channel or an O-Primary channel. In some implementations, NPCA-specific information may be included within many if not all control frames 510 (such as when the control frame 510 includes CoEx/DPS/DSO information, among other examples as disclosed herein) so that one or more recipients of the control frame 510 know that in addition to the CoEx/DPS/DSO functionality, the control frame 510 is being sent via the M-Primary channel or via the O-Primary channel.

To signal the puncturing pattern, the control frame 510 may include a punctured channel bitmap or may indicate a coded value that corresponds to a puncturing pattern. To signal which primary channel was used for transmission of the control frame 510, the control frame 510 may include a single bit to indicate that the control frame 510 was sent via the M-Primary channel or via an O-Primary channel. For example, a bit value of “0” may indicate that the control frame 510 was transmitted via the M-Primary channel and a bit value of “1” may indicate that the control frame 510 was transmitted via an O-Primary channel. Additionally, or alternatively, the control frame 510 may include multiple bits to indicate via which channel the control frame 510 was transmitted, such as in scenarios in which multiple O-Primary channels are supported. For example, a bit value of “00” may indicate that the control frame 510 was transmitted via the M-Primary channel, a bit value of “01” may indicate that the 510 was transmitted via a first O-Primary channel, and a bit value of “10” may indicate that the 510 was transmitted via a second O-Primary channel.

In accordance with the user information field list 1900, a special user information field may include an AID12/APID12 subfield 1902 indicative of an identifier value 514, an information type subfield 1904 indicative of an information type 516 corresponding to NPCA, a primary channel subfield 1906 (1 bit) to indicate which primary channel is used to transmit the control frame 510, a puncturing pattern subfield 1908 (5 or 16 bits), and a reserved subfield 1910 (variable quantity of bits). In some aspects, another special user information field may include an AID12/APID12 subfield 1912 indicative of an identifier value of 2007, a PHY version identifier subfield 1914, an uplink bandwidth extension subfield 1916, one or more EHT spatial reuse subfields 1918 (such as an EHT spatial reuse 1 subfield and an EHT spatial reuse 2 subfield), a U-SIG disregard and validate subfield 1920, a reserved bits subfield 1922 (3 bits), and a trigger dependent information subfield 1924.

In examples in which NPCA signaling is used to transmit the control frame 510, the control frame 510 may be sent in a non-HT duplicate PPDU via an O-Primary channel. The signaled puncturing pattern may be set to (3×996) tone multi-RU (MRU) 1. A control response frame 520, such as an ICR, may be sent in a non-HT duplicate PPDU via the O-Primary channel and may have a replicated punctured pattern of (3×996) tone MRU1. PPDUs after the initial control frame exchange (such as after the ICF-ICR exchange) may follow a same puncturing pattern as the initial control frame exchange. In some aspects, an ICF may be similar to or function with similarity to a request-to-send (RTS), an ICR may be similar to or function with similarity to a clear-to-send (CTS), and a CRF may be similar to or function with similarity to a BA.

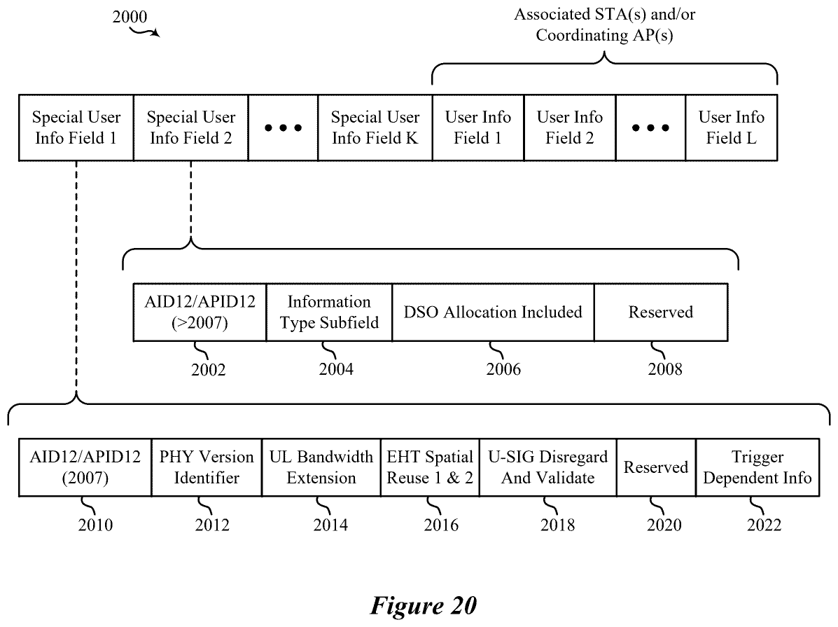

FIG. 20 shows an example user information field list 2000 associated with various signaling types that supports unified ICF designs. The user information field list 2000 may indicate example contents of an information container 512 in implementations in which an indicated information type 516 corresponds to DSO signaling type or functionality.

In some examples, a DSO ICF (the control frame 510) may include an explicit indication that the ICF is serving as a DSO ICF to at least one of the non-AP STAs addressed in the ICF. Without such an indication, a receiver processing the DSO ICF may become complicated. To signal such an explicit indication, the control frame 510 may include a single bit. The single bit may be set to a “1” value to indicate that the control frame 510 includes at least one user information field addressed to a non-AP STA whose RU allocation is outside of the non-AP STA's operating bandwidth. Such a bit may be set to a “0” value otherwise. Thus, the bit may function as an indication of whether the control frame 510 is DSO ICF. In some aspects, DSO-specific information may be included in many if not all ICFs (such as when the ICF includes CoEx/DPS/NPCA information, among other examples disclosed herein) so that the recipient(s) know that, in addition to the CoEx/DPS/NPCA functionality, the ICF is also allocating an RU to one or more non-AP STAs outside of their operating bandwidth.

In accordance with the user information field list 2000, a special user information field may include an AID12/APID12 subfield 2002 indicative of an identifier value 514, an information type subfield 2004 indicative of an information type 516 corresponding to DSO, a DSO allocation included subfield 2006 (1 bit), and a reserved bits subfield 2008 (variable quantity of bits). In some aspects, another special user information field may include an AID12/APID12 subfield 2010 indicative of an identifier value of 2007, a PHY version identifier subfield 2012, an uplink bandwidth extension subfield 2014, one or more EHT spatial reuse subfields 2016 (such as an EHT spatial reuse 1 subfield and an EHT spatial reuse 2 subfield), a U-SIG disregard and validate subfield 2018, a reserved bits subfield 2020 (3 bits), and a trigger dependent information subfield 2022.

Further, while some example information containers are illustrated or described as including specific subfields or as being located within one or more specific fields, any combination of the example information containers located with any one or more of the example fields disclosed herein may be used without exceeding the scope of the present disclosure.

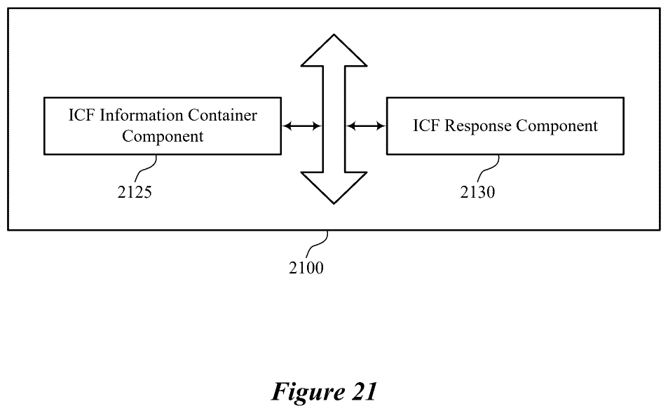

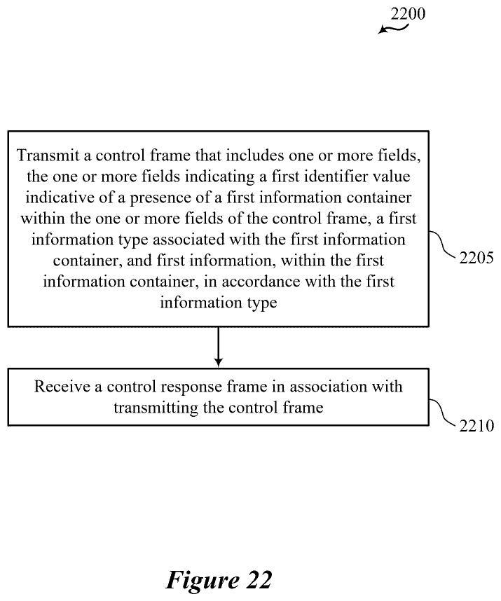

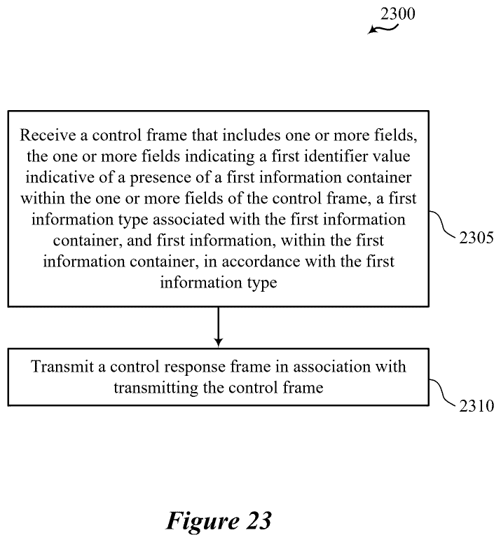

FIG. 21 shows a block diagram of an example wireless communication device 2100 that supports unified ICF designs. In some examples, the wireless communication device 2100 is configured to perform the processes 2200 and 2300 described with reference to FIGS. 22 and 23, respectively. The wireless communication device 2100 may include one or more chips, SoCs, chipsets, packages, components or devices that individually or collectively constitute or include a processing system. The processing system may interface with other components of the wireless communication device 2100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 2100 may transmit the information output from the chip. In such an example, the second interface may refer to an interface between the processing system of the chip and a reception component, such that the wireless communication device 2100 may receive information that is passed to the processing system. In some such examples, the first interface also may obtain information, such as from the transmission component, and the second interface also may output information, such as to the reception component.

The processing system of the wireless communication device 2100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2100 can be configurable or configured for use in an AP or STA, such as the AP 102 or the STA 104 described with reference to FIG. 1. In some other examples, the wireless communication device 2100 can be an AP or STA that includes such a processing system and other components including multiple antennas. The wireless communication device 2100 is capable of transmitting and receiving wireless communications in the form of, for example, wireless packets. For example, the wireless communication device 2100 can be configurable or configured to transmit and receive packets in the form of physical layer PPDUs and MPDUs conforming to one or more of the IEEE 802.11 family of wireless communication protocol standards. In some other examples, the wireless communication device 2100 can be configurable or configured to transmit and receive signals and communications conforming to one or more 3GPP specifications including those for 5G NR or 6G. In some examples, the wireless communication device 2100 also includes or can be coupled with one or more application processors which may be further coupled with one or more other memories. In some examples, the wireless communication device 2100 further includes a user interface (UI) (such as a touchscreen or keypad) and a display, which may be integrated with the UI to form a touchscreen display that is coupled with the processing system. In some examples, the wireless communication device 2100 may further include one or more sensors such as, for example, one or more inertial sensors, accelerometers, temperature sensors, pressure sensors, or altitude sensors, that are coupled with the processing system. In some examples, the wireless communication device 2100 further includes at least one external network interface coupled with the processing system that enables communication with a core network or backhaul network that enables the wireless communication device 2100 to gain access to external networks including the Internet.

The wireless communication device 2100 includes an ICF information container component 2125 and an ICF response component 2130. Portions of one or more of the ICF information container component 2125 and the ICF response component 2130 may be implemented at least in part in hardware or firmware. For example, one or more of the ICF information container component 2125 and the ICF response component 2130 may be implemented at least in part by at least a processor or a modem. In some examples, portions of one or more of the ICF information container component 2125 and the ICF response component 2130 may be implemented at least in part by a processor and software in the form of processor-executable code stored in memory.

The wireless communication device 2100 may support wireless communication in accordance with examples as disclosed herein. The ICF information container component 2125 is configurable or configured to transmit a control frame that includes one or more fields, the one or more fields indicating a first identifier value (such as a value of an AID12/APID12 subfield that includes 12 bits, with the first identifier value being greater than 2007 except for 2045, 2046, and 4095, and with the first identifier value sometimes being equal to 2008) indicative of a presence of a first information container within the one or more fields of the control frame, a first information type (which may be indicated by an information type subfield of 4 bits) associated with the first information container, and first information, within the first information container, in accordance with the first information type. The first information may be the content of one or more information subfields, whose structure and length may depend on the information type. The ICF response component 2130 is configurable or configured to receive a control response frame in association with transmitting the control frame. The control response frame may be a multi-STA block acknowledgment (BA or “BlockAck”) frame, among other examples.

Additionally, or alternatively, the ICF information container component 2125 is configurable or configured to receive a control frame that includes one or more fields, the one or more fields indicating a first identifier value indicative of a presence of a first information container within the one or more fields of the control frame, a first information type associated with the first information container, and first information, within the first information container, in accordance with the first information type. In some examples, the ICF response component 2130 is configurable or configured to transmit a control response frame in association with transmitting the control frame.

In some examples, the one or more fields include an identifier subfield. In some examples, the identifier subfield indicates the first identifier value indicative of the presence of the first information container within the one or more fields. In some examples, the identifier subfield is an AID subfield or an APID subfield. In some examples, the first identifier value is within an inclusive range of between 2008 and 2044 or between 2047 and 4094. In some examples, the first information container includes common information associated with a version of the control frame.

In some examples, the one or more fields include an information type subfield. In some examples, the information type subfield indicates the first information type from a set of multiple information types. The set of multiple information types may be listed in a table. For example, a table may list different feedback types to indicate which information is being carried in the control frame, and the information type subfield may indicate the first information type from, using, via, or otherwise in accordance with the table. In some examples, the first identifier value indicates the first information type, from a set of multiple information types, in accordance with a mapping between a set of multiple identifier values and the set of multiple information types. In some examples, each identifier value of the set of multiple identifier values indicates a respective information type from the set of multiple information types in accordance with the mapping. In some examples, the set of multiple identifier values is within an inclusive range of between 2008 and 2044 and between 2047 and 4094.

In some examples, the first information type is associated with a purpose (such as a function, intention, capability, use, manner, signaling type, version, or generation) of the control frame. In some examples, the first information is in accordance with the purpose of the control frame. In some examples, the first information type corresponds to a signaling type. In some examples, the signaling type is associated with a version of the control frame.

In some examples, the one or more fields include one or more information subfields. In some examples, the one or more information subfields indicate the first information in accordance with the first information type. In some examples, a length of the one or more information subfields is associated with the first information type. In some examples, each information type of a set of multiple information types is associated with a respective length of the one or more information subfields. In some examples, the one or more fields include an information length subfield. In some examples, the information length subfield indicates a length of the one or more information subfields.

In some examples, the one or more fields include a set of multiple information type subfields including a first information type subfield indicative of the first information type and a second information type subfield indicative of a second information type. In some examples, the one or more fields include a set of multiple sets of information subfields including a first set of one or more information subfields indicative of the first information and a second set of one or more information subfields indicative of second information, the second information in accordance with the second information type.

In some examples, the one or more fields include an information type count subfield. In some examples, the information type count subfield indicates a quantity of the set of multiple information type subfields. In some examples, each set of information subfields of the set of multiple sets of information subfields includes respective information in accordance with a respective information type subfield of the set of multiple information type subfields.

In some examples, the one or more fields include a set of multiple information length subfields. In some examples, each information length subfield of the set of multiple information length subfields indicates a respective length of a respective set of information subfields of the set of multiple sets of information subfields.

In some examples, an order of the set of multiple information type subfields and the set of multiple sets of information subfields is in accordance with a time sensitivity associated with each information type of a set of multiple information types indicated by the set of multiple information type subfields.

In some examples, the first information container includes the first information type subfield and the first set of one or more information subfields. In some examples, a second information container includes the second information type subfield and the second set of one or more information subfields.

In some examples, the one or more fields include a common information field, one or more user information fields, an information control field, or any combination thereof.

In some examples, the one or more fields include at least a first field and a second field. In some examples, the first field includes an indication that at least a portion of the first information is within the second field. In some examples, the first field and the second field each include a respective identifier subfield indicating the first identifier value. In some examples, the first field and the second field each include a respective information type subfield indicating the first information type. In some examples, the first field includes a first information type subfield indicative of the first information type and the second field excludes an information type subfield indicative of the first information type.

In some examples, the indication that at least the portion of the first information is within the second field includes a single bit indicating whether the first information is entirely within the first field or is distributed across the first field and the second field; an information length subfield indicating a length of one or more information subfields that indicate the first information, the information length subfield indicating that at least the portion of the first information is within the second field in accordance with indicating a quantity of octets unable to fit entirely within the first field; or a field count subfield indicating a quantity of fields that collectively include the first information.

In some examples, the second field conditionally indicates a second information type and second information in accordance with the second information type. In some examples, the second field indicates the second information type and at least a portion of the second information in association with a remaining quantity of bits within the second field, after the portion of the first information, satisfying a threshold quantity of bits. In some examples, a third field subsequent to the second field indicates the second information type and at least a portion of the second information in association with a remaining quantity of bits within the second field, after the portion of the first information, failing to satisfy a threshold quantity of bits.

In some examples, the control frame solicits the control response frame. In some examples, the control frame indicates whether the control response frame is to be associated with a TB-PPDU format or a non-TB PPDU format.

In some examples, the first information type corresponds to a C-TDMA signaling type. In some examples, the first information includes one or more of an indication of an allowed traffic during a shared TXOP, an indication of an estimated time at which the shared TXOP is to be shared, and an indication of an estimated duration of the shared TXOP.

In some examples, the first information type corresponds to a coexistence signaling type. In some examples, the first information includes one or more of an indication of an applicability to one or both of transmission and reception, an indication of an unavailability period start time, and an indication of an unavailability period duration.

In some examples, the first information type corresponds to a CBF signaling type. In some examples, the first information includes one or more of an indication of a CBF PPDU duration, an indication of a quantity of STAs scheduled during a CBF TXOP, an indication of one or more STA identifiers corresponding to the quantity of STAs scheduled during the CBF TXOP, an indication of a shared AP identifier, and an indication of a BA RU allocation.

In some examples, the first information type corresponds to a C-SR signaling type. In some examples, the first information includes one or more of an indication of a CAP scheme, an indication of a C-SR PPDU duration, an indication of a shared AP identifier, an indication of a BA RU allocation, and an indication of an allowed transmit power or transmit power backoff.

In some examples, the first information type corresponds to a dynamic puncturing signaling type. In some examples, the first information includes an indication of a puncturing pattern.

In some examples, the first information type corresponds to a NPCA signaling type. In some examples, the first information includes one or more of an indication of a puncturing pattern and an indication of which primary channel was used to transmit a PPDU carrying the control frame.

In some examples, the first information type corresponds to a DSO signaling type. In some examples, the first information includes an indication that a DSO allocation is included within the control frame.

In some examples, the one or more fields include a user information field including the first identifier value. In some examples, the first identifier value is within a first inclusive range of between 2008 and 2044 or between 2047 and 4094. In some examples, the user information field is located after one or more other user information fields including identifier values within a second inclusive range of between 1 and 2007.

In some examples, the user information field is located after the one or more other user information fields including the identifier values within the second inclusive range of between 1 and 2007 in accordance with a rule. In some examples, the rule is applicable in accordance with the control frame triggering at least one station incapable of parsing the first information container.

In some examples, the one or more fields include a user information field including the first identifier value. In some examples, the first identifier value is within an inclusive range of between 2008 and 2044 or between 2047 and 4094. In some examples, the user information field is located after a padding field of the control frame.

In some examples, the one or more fields include a user information field including the first identifier value. In some examples, the first identifier value is within an inclusive range of between 2008 and 2044 or between 2047 and 4094. In some examples, the user information field is located after a field including a second identifier value of 4095. In some examples, the control frame excludes a user information field including an identifier value corresponding to a station incapable of parsing the first information container.

In some examples, the control frame includes a bitmap. In some examples, each bit of the bitmap corresponds to a respective signaling type of a set of multiple signaling types to which an information type is capable of corresponding. In some examples, each bit of the bitmap indicates whether information associated with the respective signaling type is included within the control frame. In some examples, a size of the bitmap is equal to a quantity of the set of multiple signaling types to which the information type is capable of corresponding.

In some examples, the control frame includes a first field indicative of a first set of links, from a set of multiple links supported by the wireless communication device, to which the first information is applicable. In some examples, the control frame indicates second information associated with a second information type. In some examples, a second field indicates that the second information is applicable to a second set of links from the set of multiple links.

In some examples, the first information container further includes the first identifier value or an indication of the first information type, or both. In some examples, the first information includes solicited information, unsolicited information, solicits information from one or more other wireless communication devices, or any combination thereof.

In some examples, the control frame is a unified ICF associated with one or more IEEE 802.11 standards. In some examples, the control frame includes the first information container in accordance with a version of the control frame. In some examples, the version of the control frame is a UHR version of the one or more IEEE 802.11 standards. In some examples, the control frame includes a common information field. In some examples, the common information field includes a GI and HE/EHT LTF type/TXS mode subfield (which may be referred to as a GI and HE/UHR LTF type/TXS mode subfield in a UHR system) that indicates a codepoint value of three.

FIG. 22 shows a flowchart illustrating an example process 2200 performable by or at a wireless communication device that supports unified ICF designs. The operations of the process 2200 may be implemented by a wireless communication device or its components as described herein. For example, the process 2200 may be performed by a wireless communication device, such as the wireless communication device 2100 described with reference to FIG. 21, operating as or within a wireless AP or a wireless STA. In some examples, the process 2200 may be performed by a wireless AP or a wireless STA, such as one of the APs 102 or the STAs 104 described with reference to FIG. 1.

In some examples, in 2205, the wireless communication device may transmit a control frame that includes one or more fields, the one or more fields indicating a first identifier value indicative of a presence of a first information container within the one or more fields of the control frame, a first information type associated with the first information container, and first information, within the first information container, in accordance with the first information type. The operations of 2205 may be performed in accordance with examples as disclosed herein. In some implementations, aspects of the operations of 2205 may be performed by an ICF information container component 2125 as described with reference to FIG. 21.

In some examples, in 2210, the wireless communication device may receive a control response frame in association with transmitting the control frame. The operations of 2210 may be performed in accordance with examples as disclosed herein. In some implementations, aspects of the operations of 2210 may be performed by an ICF response component 2130 as described with reference to FIG. 21.

FIG. 23 shows a flowchart illustrating an example process 2300 performable by or at a wireless communication device that supports unified ICF designs. The operations of the process 2300 may be implemented by a wireless communication device or its components as described herein. For example, the process 2300 may be performed by a wireless communication device, such as the wireless communication device 2100 described with reference to FIG. 21, operating as or within a wireless AP or a wireless STA. In some examples, the process 2300 may be performed by a wireless AP or a wireless STA, such as one of the APs 102 or the STAs 104 described with reference to FIG. 1.

In some examples, in 2305, the wireless communication device may receive a control frame that includes one or more fields, the one or more fields indicating a first identifier value indicative of a presence of a first information container within the one or more fields of the control frame, a first information type associated with the first information container, and first information, within the first information container, in accordance with the first information type. The operations of 2305 may be performed in accordance with examples as disclosed herein. In some implementations, aspects of the operations of 2305 may be performed by an ICF information container component 2125 as described with reference to FIG. 21.

In some examples, in 2310, the wireless communication device may transmit a control response frame in association with transmitting the control frame. The operations of 2310 may be performed in accordance with examples as disclosed herein. In some implementations, aspects of the operations of 2310 may be performed by an ICF response component 2130 as described with reference to FIG. 21.

Implementation examples are described in the following numbered clauses:

Clause 1: A method for wireless communication at a wireless communication device, including: communicating (such as transmitting or receiving) a control frame that includes one or more fields, the one or more fields indicating a first identifier value indicative of a presence of a first information container within the one or more fields of the control frame, a first information type associated with the first information container, and first information, within the first information container, in accordance with the first information type; and communicating (such as transmitting or receiving) a control response frame in association with transmitting the control frame.

Clause 2: The method of clause 1, where the one or more fields include an identifier subfield, and the identifier subfield indicates the first identifier value indicative of the presence of the first information container within the one or more fields.

Clause 3: The method of clause 2, where the identifier subfield is an AID subfield or an APID subfield.

Clause 4: The method of any of clauses 1-3, where the first identifier value is within an inclusive range of between 2008 and 2044 or between 2047 and 4094.

Clause 5: The method of any of clauses 1-4, where the first information container includes common information associated with a version of the control frame.

Clause 6: The method of any of clauses 1-5, where the one or more fields include an information type subfield, and the information type subfield indicates the first information type from a plurality of information types.

Clause 7: The method of any of clauses 1-6, where the first identifier value indicates the first information type, from a plurality of information types, in accordance with a mapping between a plurality of identifier values and the plurality of information types.

Clause 8: The method of clause 7, where each identifier value of the plurality of identifier values indicates a respective information type from the plurality of information types in accordance with the mapping.

Clause 9: The method of any of clauses 7-8, where the plurality of identifier values is within an inclusive range of between 2008 and 2044 and between 2047 and 4094.

Clause 10: The method of any of clauses 1-9, where the first information type is associated with a purpose of the control frame, and the first information is in accordance with the purpose of the control frame.

Clause 11: The method of any of clauses 1-10, where the first information type corresponds to a signaling type, and the signaling type is associated with a version of the control frame.

Clause 12: The method of any of clauses 1-11, where the one or more fields include one or more information subfields, and the one or more information subfields indicate the first information in accordance with the first information type.

Clause 13: The method of clause 12, where a length of the one or more information subfields is associated with the first information type.

Clause 14: The method of clause 13, where each information type of a plurality of information types is associated with a respective length of the one or more information subfields.

Clause 15: The method of any of clauses 12-14, where the one or more fields include an information length subfield, and the information length subfield indicates a length of the one or more information subfields.

Clause 16: The method of any of clauses 1-15, where the one or more fields include a plurality of information type subfields including a first information type subfield indicative of the first information type and a second information type subfield indicative of a second information type; and the one or more fields include a plurality of sets of information subfields including a first set of one or more information subfields indicative of the first information and a second set of one or more information subfields indicative of second information, the second information in accordance with the second information type.

Clause 17: The method of clause 16, where the one or more fields include an information type count subfield, and the information type count subfield indicates a quantity of the plurality of information type subfields.

Clause 18: The method of any of clauses 16-17, where each set of information subfields of the plurality of sets of information subfields includes respective information in accordance with a respective information type subfield of the plurality of information type subfields.

Clause 19: The method of any of clauses 16-18, where the one or more fields include a plurality of information length subfields, and each information length subfield of the plurality of information length subfields indicates a respective length of a respective set of information subfields of the plurality of sets of information subfields.

Clause 20: The method of any of clauses 16-19, where an order of the plurality of information type subfields and the plurality of sets of information subfields is in accordance with a time sensitivity associated with each information type of a plurality of information types indicated by the plurality of information type subfields.

Clause 21: The method of any of clauses 16-20, where the first information container includes the first information type subfield and the first set of one or more information subfields, and a second information container includes the second information type subfield and the second set of one or more information subfields.

Clause 22: The method of any of clauses 1-21, where the one or more fields include a common information field, one or more user information fields, an information control field, or any combination thereof.

Clause 23: The method of any of clauses 1-22, where the one or more fields include at least a first field and a second field, and the first field includes an indication that at least a portion of the first information is within the second field.

Clause 24: The method of clause 23, where the first field and the second field each include a respective identifier subfield indicating the first identifier value.

Clause 25: The method of any of clauses 23-24, where the first field and the second field each include a respective information type subfield indicating the first information type.

Clause 26: The method of any of clauses 23-25, where the first field includes a first information type subfield indicative of the first information type and the second field excludes an information type subfield indicative of the first information type.

Clause 27: The method of any of clauses 23-26, where the indication that at least the portion of the first information is within the second field includes a single bit indicating whether the first information is entirely within the first field or is distributed across the first field and the second field; an information length subfield indicating a length of one or more information subfields that indicate the first information, the information length subfield indicating that at least the portion of the first information is within the second field in accordance with indicating a quantity of octets unable to fit entirely within the first field; or a field count subfield indicating a quantity of fields that collectively include the first information.

Clause 28: The method of any of clauses 23-27, where the second field conditionally indicates a second information type and second information in accordance with the second information type.

Clause 29: The method of clause 28, where the second field indicates the second information type and at least a portion of the second information in association with a remaining quantity of bits within the second field, after the portion of the first information, satisfying a threshold quantity of bits.

Clause 30: The method of any of clauses 28-29, where a third field subsequent to the second field indicates the second information type and at least a portion of the second information in association with a remaining quantity of bits within the second field, after the portion of the first information, failing to satisfy a threshold quantity of bits.

Clause 31: The method of any of clauses 1-30, where the control frame solicits the control response frame, and the control frame indicates whether the control response frame is to be associated with a TB PPDU format or a non-TB PPDU format.

Clause 32: The method of any of clauses 1-31, where the first information type corresponds to a C-TDMA signaling type; and the first information includes one or more of an indication of an allowed traffic during a shared TXOP, an indication of an estimated time at which the shared TXOP is to be shared, and an indication of an estimated duration of the shared TXOP.

Clause 33: The method of any of clauses 1-32, where the first information type corresponds to a co-existence signaling type; and the first information includes one or more of an indication of an applicability to one or both of transmission and reception, an indication of an unavailability period start time, and an indication of an unavailability period duration.

Clause 34: The method of any of clauses 1-33, where the first information type corresponds to a C-BF signaling type; and the first information includes one or more of an indication of a C-BF PPDU duration, an indication of a quantity of STAs scheduled during a C-BF TXOP, an indication of one or more STA identifiers corresponding to the quantity of STAs scheduled during the C-BF TXOP, an indication of a shared AP identifier, and an indication of a BA RU allocation.

Clause 35: The method of any of clauses 1-34, where the first information type corresponds to a C-SR signaling type; and the first information includes one or more of an indication of a CAP scheme, an indication of a C-SR PPDU duration, an indication of a shared AP identifier, an indication of a BA RU allocation, and an indication of an allowed transmit power or transmit power backoff.

Clause 36: The method of any of clauses 1-35, where the first information type corresponds to a dynamic puncturing signaling type; and the first information includes an indication of a puncturing pattern.

Clause 37: The method of any of clauses 1-36, where the first information type corresponds to a NPCA signaling type; and the first information includes one or more of an indication of a puncturing pattern and an indication of which primary channel was used to transmit a PPDU carrying the control frame.

Clause 38: The method of any of clauses 1-37, where the first information type corresponds to a DSO signaling type; and the first information includes an indication that a DSO allocation is included within the control frame.

Clause 39: The method of any of clauses 1-38, where the one or more fields include a user information field including the first identifier value, the first identifier value is within a first inclusive range of between 2008 and 2044 or between 2047 and 4094, and the user information field is located after one or more other user information fields including identifier values within a second inclusive range of between 1 and 2007.

Clause 40: The method of clause 39, where the user information field is located after the one or more other user information fields including the identifier values within the second inclusive range of between 1 and 2007 in accordance with a rule, and the rule is applicable in accordance with the control frame triggering at least one station incapable of parsing the first information container.

Clause 41: The method of any of clauses 1-40, where the one or more fields include a user information field including the first identifier value, the first identifier value is within an inclusive range of between 2008 and 2044 or between 2047 and 4094, and the user information field is located after a padding field of the control frame.

Clause 42: The method of any of clauses 1-41, where the one or more fields include a user information field including the first identifier value, the first identifier value is within an inclusive range of between 2008 and 2044 or between 2047 and 4094, and the user information field is located after a field including a second identifier value of 4095.

Clause 43: The method of any of clauses 1-42, where the control frame excludes a user information field including an identifier value corresponding to a station incapable of parsing the first information container.

Clause 44: The method of any of clauses 1-43, where the control frame includes a bitmap, each bit of the bitmap corresponds to a respective signaling type of a plurality of signaling types to which an information type is capable of corresponding, and each bit of the bitmap indicates whether information associated with the respective signaling type is included within the control frame.

Clause 45: The method of clause 44, where a size of the bitmap is equal to a quantity of the plurality of signaling types to which the information type is capable of corresponding.

Clause 46: The method of any of clauses 1-45, where the control frame includes a first field indicative of a first set of links, from a plurality of links supported by the wireless communication device, to which the first information is applicable.

Clause 47: The method of clause 46, where the control frame indicates second information associated with a second information type, a second field indicates that the second information is applicable to a second set of links from the plurality of links.

Clause 48: The method of any of clauses 1-47, where the first information container further includes the first identifier value or an indication of the first information type, or both.

Clause 49: The method of any of clauses 1-48, where the first information includes solicited information, unsolicited information, solicits information from one or more other wireless communication devices, or any combination thereof.

Clause 50: The method of any of clauses 1-49, where the first identifier value indicates that the control frame is a unified ICF associated with one or more IEEE 802.11 standards, the control frame includes the first information container in accordance with a version of the control frame, and the version of the control frame is a UHR version of the one or more IEEE 802.11 standards.

Clause 51: The method of any of clauses 1-50, where the control frame includes a common information field, and where the common information field includes a GI and HE/EHT LTF type/TXS mode subfield or a GI and HE/UHR LTF type/TXS mode subfield that indicates a codepoint value of three.

Clause 52: An apparatus for wireless communication at a wireless communication device, including a processing system that includes processor circuitry and memory circuitry that stores code, the processing system configured to cause the apparatus or the wireless communication device to perform a method of any of clauses 1-51.

Clause 53: An apparatus for wireless communication at a wireless communication device, including one or more memories storing processor-executable code, and one or more processors coupled with the one or more memories and individually or collectively operable to execute the code to cause the apparatus or the wireless communication device to perform a method of any of clauses 1-51.

Clause 54: An apparatus for wireless communication at a wireless communication device, including at least one means for performing a method of any of clauses 1-51.

Clause 55: A non-transitory computer-readable medium storing code for wireless communication, the code including instructions executable by one or more processors to perform a method of any of clauses 1-51.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information) or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at a wireless communication device, comprising:
a processing system that includes processor circuitry and memory circuitry that stores code, the processing system configured to cause the apparatus to:
transmit a control frame that comprises one or more fields, the one or more fields indicating:
a first identifier value indicative of a presence of a first information container within the one or more fields of the control frame,
a first information type associated with the first information container, and
first information, within the first information container, in accordance with the first information type; and
receive a control response frame in association with transmitting the control frame.

2. The apparatus of claim 1, wherein:
the one or more fields comprise an identifier subfield, and
the identifier subfield indicates the first identifier value indicative of the presence of the first information container within the one or more fields.

3. The apparatus of claim 1, wherein the first identifier value is within an inclusive range of between 2008 and 2044 or between 2047 and 4094.

4. The apparatus of claim 1, wherein the first information container comprises common information associated with a version of the control frame.

5. The apparatus of claim 1, wherein:
the one or more fields comprise an information type subfield, and
the information type subfield indicates the first information type from a plurality of information types.

6. The apparatus of claim 1, wherein:
the first information type corresponds to a signaling type, and
the signaling type is associated with a version of the control frame.

7. The apparatus of claim 1, wherein the one or more fields comprise one or more user information fields.

8. The apparatus of claim 1, wherein the first identifier value indicates that the control frame is a unified initial control frame (ICF) associated with one or more Institute of Electrical and Electronics Engineers (IEEE) 802.11 standards.

9. An apparatus for wireless communication at a wireless communication device, comprising:
a processing system that includes processor circuitry and memory circuitry that stores code, the processing system configured to cause the apparatus to:
receive a control frame that comprises one or more fields, the one or more fields indicating:
a first identifier value indicative of a presence of a first information container within the one or more fields of the control frame,
a first information type associated with the first information container, and
first information, within the first information container, in accordance with the first information type; and
transmit a control response frame in association with transmitting the control frame.

10. The apparatus of claim 9, wherein:
the first identifier value is within an inclusive range of between 2008 and 2044 or between 2047 and 4094; and
the first identifier value indicates that the control frame is a unified initial control frame (ICF) associated with one or more Institute of Electrical and Electronics Engineers (IEEE) 802.11 standards.

11. The apparatus of claim 9, wherein the control frame comprises a common information field, and wherein the common information field comprises a guard interval (GI) and high efficiency/ultra-high reliability (HE/UHR) long training field (LTF) type/transmission opportunity sharing (TXS) mode subfield that indicates a codepoint value of three.

12. The apparatus of claim 9, wherein the first identifier value is equal to 2008.

13. A method for wireless communication at a wireless communication device, comprising:
transmitting a control frame that comprises one or more fields, the one or more fields indicating:
a first identifier value indicative of a presence of a first information container within the one or more fields of the control frame,
a first information type associated with the first information container, and
first information, within the first information container, in accordance with the first information type; and
receiving a control response frame in association with transmitting the control frame.

14. The method of claim 13, wherein:
the first information type corresponds to a coordinated time division multiple access (C-TDMA) signaling type; and
the first information comprises one or more of an indication of an allowed traffic during a shared transmission opportunity (TXOP), an indication of an estimated time at which the shared TXOP is to be shared, and an indication of an estimated duration of the shared TXOP.

15. The method of claim 13, wherein:
the first information type corresponds to a coexistence (CoEx) signaling type; and
the first information comprises one or more of an indication of an applicability to one or both of transmission and reception, an indication of an unavailability period start time, and an indication of an unavailability period duration.

16. The method of claim 13, wherein:
the first information type corresponds to a coordinated beamforming (CBF) signaling type; and
the first information comprises one or more of an indication of a CBF physical layer (PHY) protocol data unit (PPDU) duration, an indication of a quantity of stations (STAs) scheduled during a CBF transmission opportunity (TXOP), an indication of one or more STA identifiers corresponding to the quantity of STAs scheduled during the CBF TXOP, an indication of a shared access point (AP) identifier, and an indication of a block acknowledgment (BA) resource unit (RU) allocation.

17. The method of claim 13, wherein:
the first information type corresponds to a coordinated spatial reuse (C-SR) signaling type; and
the first information comprises one or more of an indication of a coordinated access point (CAP) scheme, an indication of a C-SR physical layer (PHY) protocol data unit (PPDU) duration, an indication of a shared access point (AP) identifier, an indication of a block acknowledgment (BA) resource unit (RU) allocation, and an indication of an allowed transmit power or transmit power backoff.

18. The method of claim 13, wherein:
the first information type corresponds to a dynamic puncturing signaling type; and
the first information comprises an indication of a puncturing pattern.

19. The method of claim 13, wherein:
the first information type corresponds to a non-primary channel access (NPCA) signaling type; and
the first information comprises one or more of an indication of a puncturing pattern and an indication of which primary channel was used to transmit a physical layer (PHY) protocol data unit (PPDU) carrying the control frame.

20. The method of claim 13, wherein:
the first information type corresponds to a dynamic subchannel operation (DSO) signaling type; and
the first information comprises an indication that a DSO allocation is comprised within the control frame.
